(19) United States
(12) Patent Application Publication
(10) Pub. No.: US 2024/0135218 A1
(43) Pub. Date: Apr. 25, 2024

(54) SYSTEMS AND METHODS FOR QUANTUM ANNEALING-ASSISTED MACHINE LEARNING

(71) Applicant: D-WAVE SYSTEMS INC., Burnaby (CA)

(72) Inventor: Mohammad H. Amin, Coquitlam (CA)

(21) Appl. No.: 18/241,499

(22) Filed: Sep. 1, 2023

Related U.S. Application Data
(60) Provisional application No. 63/413,325, filed on Oct. 5, 2022.

(51) Int. Cl. G06N 10/20

(52) U.S. Cl. CPC G06N 10/20

(57) ABSTRACT

There is provided a system and methods of training and predicting an outcome using quantum annealing-assisted reservoir computing. The methods are performed by a digital computer in communication with a quantum processor including a plurality of qubits. Methods include: receiving input data; initializing first states of the qubits; and, for each input: determining values of Hamiltonian parameters based on the input, programming the quantum processor based on the determined Hamiltonian parameters, performing an annealing protocol to evolve the qubits to second states, and applying a linear transformation to the second states to determine a predicted output. During training, a set of linear parameter weights are optimized using linear regression. As part of the annealing protocol, reverse annealing is performed to a point in the quantum critical region having maximally complex dynamics, therefore measured second states are highly separable in the higher dimensional space for providing high-accuracy predicted outputs.

### FIELD

This disclosure generally relates to systems and methods for quantum-assisted machine learning, and, more specifically, to systems and methods for quantum annealing-assisted reservoir computing.

### BACKGROUND

### Quantum Devices

Quantum devices are structures in which quantum mechanical effects are observable. Quantum devices include circuits in which current transport is dominated by quantum mechanical effects. Such devices include spintronics, and superconducting circuits. Both spin and superconductivity are quantum mechanical phenomena. Quantum devices can be used for measurement instruments, in computing machinery, and the like.

### Quantum Computation

A quantum computer is a system that makes direct use of at least one quantum-mechanical phenomenon, such as superposition, tunneling, and entanglement, to perform operations on data. The elements of a quantum computer are qubits. Quantum computers can provide speedup for certain classes of computational problems such as computational problems simulating quantum physics.

### Superconducting Qubits

Superconducting qubits are solid state qubits based on circuits of superconducting materials. Operation of superconducting qubits is based on the underlying principles of magnetic flux quantization, and Josephson tunneling. Superconducting effects can be present in different configurations, and can give rise to different types of superconducting qubits including flux, phase, charge, and hybrid qubits. The different configurations can vary in the topology of the loops, the placement of the Josephson junctions, and the physical parameters of elements of the superconducting circuits, such as inductance, capacitance, and Josephson junction critical current.

### Superconducting Processor

A computer processor may take the form of a superconducting processor, in which the superconducting processor may not be a quantum processor in the traditional sense. For instance, some embodiments of a superconducting processor may not focus on quantum effects such as quantum tunneling, superposition, and entanglement but may rather operate by emphasizing different principles, such as for example the principles that govern the operation of classical computer processors. However, there may still be certain advantages to the implementation of such superconducting “classical” processors. Due to their natural physical properties, superconducting classical processors may be capable of higher switching speeds and shorter computation times than non-superconducting processors, and therefore it may be more practical to solve certain problems on superconducting classical processors. The present systems and methods are particularly well-suited for use in fabricating both superconducting quantum processors and superconducting classical processors.

### Quantum Processor

A quantum processor may take the form of a superconducting quantum processor. A superconducting quantum processor may include a number of superconducting qubits and associated local bias devices. A superconducting quantum processor may also include couplers (also known as coupling devices) that selectively provide communicative coupling between qubits.

In one implementation, the superconducting qubit includes a superconducting loop interrupted by a Josephson junction. The ratio of the inductance of the Josephson junction to the geometric inductance of the superconducting loop can be expressed as 2πLI_{C}/Φ₀, where L is the geometric inductance, I_{C} is the critical current of the Josephson junction, and Φ₀ is the flux quantum. The inductance and the critical current can be selected, adjusted, or tuned, to increase the ratio of the inductance of the Josephson junction to the geometric inductance of the superconducting loop, and to cause the qubit to be operable as a bistable device. In some implementations, the ratio of the inductance of the Josephson junction to the geometric inductance of the superconducting loop of a qubit is approximately equal to three.

In one implementation, the superconducting coupler includes a superconducting loop interrupted by a Josephson junction. The inductance and the critical current can be selected, adjusted, or tuned, to decrease the ratio of the inductance of the Josephson junction to the geometric inductance of the superconducting loop, and to cause the coupler to be operable as a monostable device. In some implementations, the ratio of the inductance of the Josephson junction to the geometric inductance of the superconducting loop of a coupler is approximately equal to, or less than, one.

Further details and embodiments of example quantum processors that may be used in conjunction with the present systems and devices are described in, for example, U.S. Pat. Nos. 7,533,068; 8,008,942; 8,195,596; 8,190,548; and 8,421,053.

### Adiabatic Quantum Computation

A Hamiltonian is an operator whose eigenvalues are the allowed energies of the system. Adiabatic quantum computation can include evolving a system from an initial Hamiltonian to a final Hamiltonian by a gradual change. One example of adiabatic evolution is a linear interpolation between the initial Hamiltonian Hᵢ and the final Hamiltonian H_{f}, as follows:

Hₑ=(1−s)Hᵢ+sH_{f}

where Hₑ is the evolution, or instantaneous, Hamiltonian, and s is an evolution coefficient that can control the rate of evolution.

As the system evolves, the evolution coefficient s changes value from 0 to 1. At the start, the evolution Hamiltonian Hₑ is equal to the initial Hamiltonian Hᵢ, and, at the end, the evolution Hamiltonian Hₑ is equal to the final Hamiltonian H_{f}.

The system is typically initialized in a ground state of the initial Hamiltonian Hᵢ, and the goal of the adiabatic evolution is to evolve the system such that it ends up in a ground state of the final Hamiltonian H_{f} at the end of the evolution. If the evolution is too fast, then the system can transition to a higher energy state of the system, such as the first excited state.

The process of changing the Hamiltonian in adiabatic quantum computing may be referred to as evolution. An adiabatic evolution is an evolution that satisfies an adiabatic condition such as:

\dot{s}| [symbol] 1|dHₑ/ds|0 [symbol] |=δg²(s)

where \dot{s} is the time derivative of s, g(s) is the difference in energy between the ground state and first excited state of the system (also referred to herein as the gap size) as a function of s, and δ is a coefficient and δ<<1.

If the rate of change (for example, \dot{s}), is slow enough that the system is always in the instantaneous ground state of the evolution Hamiltonian, then transitions at anti-crossings (i.e., when the gap size is smallest) are avoided. The equation for the evolution Hamiltonian above is an example of a linear evolution schedule. Other evolution schedules can be used, including non-linear, parametric, and the like. Further details on adiabatic quantum computing systems, methods, and apparatus are described in, for example, U.S. Pat. Nos. 7,135,701; and 7,418,283.

### Quantum Annealing

Quantum annealing is a computational method that may be used to find a low-energy state of a system, typically preferably the ground state of the system. Similar in concept to classical simulated annealing, the method relies on the underlying principle that natural systems tend towards lower energy states because lower energy states are more stable. While classical annealing uses classical thermal fluctuations to guide a system to a low-energy state, quantum annealing may use quantum effects, such as quantum tunneling, as a source of delocalization to reach an energy minimum more accurately and/or more quickly than classical annealing.

A quantum processor may be designed to perform quantum annealing and/or adiabatic quantum computation. An evolution Hamiltonian can be constructed that is proportional to the sum of a first term proportional to a problem Hamiltonian and a second term proportional to a delocalization Hamiltonian, as follows:

H_{E}∝A(t)H_{P}+B(t)H_{D}

where H_{E} is the evolution Hamiltonian, H_{P} is the problem Hamiltonian, H_{D} is the delocalization Hamiltonian, and A(t), B(t) are coefficients that can control the rate of evolution, and typically lie in the range [0,1].

In some implementations, a time varying envelope function can be placed on the problem Hamiltonian. A suitable delocalization Hamiltonian is given by:

$${H}_{D} ∝ - \frac{1}{2} {\sum }_{i = 1}^{N} {Δ}_{i} {σ}_{i}^{x}$$

where N represents the number of qubits, σᵢ^{x} is the Pauli x-matrix for the i^{th} qubit and Δᵢ is the single qubit tunnel splitting induced in the i^{th} qubit. Here, the σᵢ^{x} terms are examples of “off-diagonal” terms.

A common problem Hamiltonian includes a first component proportional to diagonal single qubit terms and a second component proportional to diagonal multi-qubit terms, and may be of the following form:

$${H}_{P} ∝ - \frac{ε}{2} [ {\sum }_{i = 1}^{N} {h}_{i} {σ}_{i}^{z} + {\sum }_{j > i}^{N} {J}_{i j} {σ}_{i}^{z} {σ}_{j}^{z} ]$$

where N represents the number of qubits, σᵢ^{z} is the Pauli z-matrix for the i^{th} qubit, hᵢ and Jᵢⱼ are dimensionless local fields for the qubits, and couplings between qubits, and ε is some characteristic energy scale for H_{P}.

Here, the σᵢ^{z} and σᵢ^{z}σⱼ^{z} terms are examples of “diagonal” terms. The former is a single qubit term and the latter a two qubit term.

Throughout this specification, the terms “problem Hamiltonian” and “final Hamiltonian” are used interchangeably unless the context dictates otherwise. Certain states of the quantum processor are, energetically preferred, or simply preferred by the problem Hamiltonian. These include the ground states but may include excited states.

Hamiltonians such as H_{D} and H_{P} in the above two equations, respectively, may be physically realized in a variety of different ways. A particular example is realized by an implementation of superconducting qubits.

### Sampling

Throughout this specification and the appended claims, the terms “sample”, “sampling”, “sampling device”, and “sample generator” are used. These terms are used herein in like manner to their corresponding uses in the arts of statistics and statistical analysis, and electrical engineering.

In statistics, a sample is a subset of a population, i.e., a selection of data taken from a statistical population. Sampling is the process of taking the sample, and typically follows a defined procedure. For example, in a population, database, or collection of objects, a sample may refer to an individual datum, data point, object, or subset of data, data points, and/or objects.

In electrical engineering and related disciplines, sampling relates to taking a set of measurements of an analog signal or some other physical system. Sampling may include conversion of a continuous signal to a discrete signal.

In many fields, including simulations of physical systems, and computing, especially analog computing, the foregoing meanings may merge. For example, a hybrid computer can draw samples from an analog computer. The analog computer, as a provider of samples, is an example of a sample generator. The analog computer can be operated to provide samples from a selected probability distribution, the probability distribution assigning a respective probability of being sampled to each data point in the population.

An analog processor, for example a quantum processor and in particular a quantum processor designed to perform quantum annealing and/or adiabatic quantum computation, may be operated as a sample generator. The population can correspond to all possible states of the processor, and each sample can correspond to a respective state of the processor. Using an analog processor as a sample generator may be a preferred mode of operating the processor for certain applications. Operating an analog processor as a sample generator may also enable a broader range of problems to be solved compared to, for example, using an analog processor to find a low energy state of a Hamiltonian that encodes an optimization problem.

### Machine Learning

Machine learning relates to methods and circuitry that can learn from data and make predictions based on data. In contrast to methods or circuitry that follow static program instructions, machine learning methods and circuitry can include deriving a model from example inputs (such as a training set) and then making data-driven predictions.

Machine learning is related to optimization. Some problems can be expressed in terms of minimizing a loss function on a training set, in which the loss function describes the disparity between the predictions of the model being trained and observable data.

Machine learning tasks can include unsupervised learning, supervised learning, and reinforcement learning. Approaches to machine learning include, but are not limited to, decision trees, linear and quadratic classifiers, case-based reasoning, Bayesian statistics, and artificial neural networks.

Machine learning can be used in situations in which explicit approaches are considered infeasible. Example application areas include optical character recognition, search engine optimization, and computer vision.

The foregoing examples of the related art and limitations related thereto are intended to be illustrative and not exclusive. Other limitations of the related art will become apparent to those of skill in the art upon a reading of the specification and a study of the drawings.

### BRIEF SUMMARY

Reservoir computing can be used to determine a predicted output for input signals in a time-series dataset based on a mapping of the inputs to higher dimensional computational spaces based on non-linear dynamics of a fixed system (i.e., a “reservoir”), and an application of a linear transformation on the mapped output. A complexity of the reservoir dynamics corresponds with the linear separability of the reservoir output and thus the efficacy of the predicted output.

Quantum processors can be used as physical reservoirs with a low-computational cost due to the inherent, available non-linear dynamics of qubits therewithin. Gate-model quantum processors can provide a reservoir through a sequence of fixed gate circuits; however, limitations in circuit depth may prevent computation at a suitably high dimension for reservoir computing, circuits may need to be executed a large number of times to obtain outputs, and Hamiltonian parameters remain fixed throughout computation.

To realize the advantages of quantum reservoir computing, a quantum annealing processor is described herein that can be used as a physical reservoir with advantageously complex dynamics, a high dimensional computation space, and a fading memory. The quantum annealing processor can execute according to an annealing protocol that includes performance of reverse annealing to a point at which quantum system dynamics are most complex, and subsequent performance of forward annealing to evolve the quantum annealing processor to a final state. The reproducibility and controllability of system dynamics ensure that the highly separable output of the physical reservoir retains time-series relevance to the input data to provide accurate predictions.

A method to train an output layer of a reservoir computer performed by at least one digital computer in communication with at least one quantum processor can be provided. The at least one quantum processor can include a plurality of qubits. The method can include: receiving, by the at least one digital computer, a dataset comprised of a plurality of data points, each data point including an input and a corresponding target output; and initializing, by the at least one digital computer, states of the plurality of qubits to a first state. For each data point in the dataset, the method can include: determining, by the at least one digital computer, values of Hamiltonian parameters based on the input; programming, by the at least one digital computer, the at least one quantum processor based on the determined Hamiltonian parameters; causing, by at least one digital computer, the at least one quantum processor to perform quantum annealing according to an annealing protocol to evolve each qubit of the plurality of qubits to a respective second state, in which the annealing protocol comprises performance of reverse quantum annealing; causing, by the at least one digital computer, measurement of the respective second state of each qubit of the plurality of qubits and transmission of measured second states of the plurality of qubits to the digital computer; applying, by the at least one digital computer, a linear transformation to the measured second states of the plurality of qubits to obtain a predicted output, the linear transformation including a set of linear parameter weights; and, for a subsequent data point in the dataset, setting, by the at least one digital computer, first states of the plurality of qubits to the measured second states of the plurality of qubits. The method can also include: optimizing, by the at least one digital computer, the set of linear parameter weights, in which the optimizing is based on the predicted output and the target output for all data points in the dataset.

In some implementations, the causing the at least one quantum processor to perform quantum annealing according to an annealing protocol can include performing reverse quantum annealing until a point close or at least proximate a quantum critical point (i.e., in a quantum critical region) is reached, such that quantum fluctuations induce a change in state of each qubit of the plurality of qubits.

In some implementations, after the performing reverse quantum annealing until the point close or at least proximate a quantum critical point (i.e., in the quantum critical region) is reached, the causing the at least one quantum processor to perform quantum annealing according to an annealing protocol can further include causing, by at least one digital computer, the at least one quantum processor to perform forward quantum annealing until each qubit in the plurality of qubits has a respective classical state. The respective classical state of each qubit can be the respective second state.

In some implementations, the determining values of Hamiltonian parameters based on the input can include determining values of Hamiltonian parameters for a spin glass Hamiltonian model having parameters that are a function of the input.

In some implementations, the determining values of Hamiltonian parameters based on the input can include one of: directly translating the input into the Hamiltonian parameters, applying a transformation to the input, and feeding the input into a machine learning model.

In some implementations, the initializing states of the plurality of qubits to a first state can include initializing a state of each qubit of the plurality of qubits to a same classical state or a same state of superposition.

In some implementations, the optimizing the set of linear parameter weights can include minimizing a distance between the predicted output and the corresponding target output using a cost function.

In some implementations, the optimizing the set of linear parameter weights can include performing linear regression on the predicted output and the target output for all data points in the dataset.

A method of determining a predicted outcome for an input value using a reservoir computer performed by at least one digital computer in communication with at least one quantum processor can be provided. The at least one quantum processor can include a plurality of qubits. The method can include: receiving, by the at least one digital processor, the input value; initializing, by the at least one digital processor, states of the plurality of qubits to a first state; determining, by the at least one digital processor, values of Hamiltonian parameters based on the input value; programming, by the at least one digital processor, the at least one quantum processor based on the determined Hamiltonian parameters; causing, by the at least one digital processor, the at least one quantum processor to perform quantum annealing according to an annealing protocol to evolve each qubit of the plurality of qubits to a respective second state, in which the annealing protocol includes performance of reverse quantum annealing; causing, by the at least one digital processor, a measurement of the respective second state of each qubit of the plurality of qubits and transmission of measured second states of the plurality of qubits to the digital computer; and, applying, by the at least one digital processor, a linear transformation to the measured second states of the plurality of qubits to obtain a predicted output value, the linear transformation including a set of linear parameter weights.

In some implementations, the causing the at least one quantum processor to perform quantum annealing according to an annealing protocol can include causing the at least one quantum processor to perform reverse quantum annealing until a point close or at least proximate a quantum critical point (i.e., in a quantum critical region) is reached, such that quantum fluctuations induce a change in state of each qubit of the plurality of qubits.

In some implementations, after performing the reverse quantum annealing until the point close or at least proximate a quantum critical point (i.e., in the quantum critical region) is reached, the causing the at least one quantum processor to perform quantum annealing according to an annealing protocol can further include causing the at least one quantum processor to perform forward quantum annealing until each qubit in the plurality of qubits has a respective classical state. The respective classical state of each qubit can be the respective second state.

In some implementations, the determining values of Hamiltonian parameters based on the input can include determining values of Hamiltonian parameters for a spin glass Hamiltonian model having parameters that are a function of the input value.

In some implementations, the determining values of Hamiltonian parameters based on the input value can include one of: directly translating the input value into the Hamiltonian parameters, applying a transformation to the input value, and feeding the input value into a machine learning model.

In some implementations, the initializing states of the plurality of qubits to a first state can include initializing the state of each qubit of the plurality of qubits to a same classical state or a same random state.

In some implementations, the input value is a vector of input values, and the following acts are performed sequentially for each input value in the vector of input values: the determining values of Hamiltonian parameters based on the input value; the programming the at least one quantum processor to have the determined Hamiltonian parameters; the causing the at least one quantum processor to perform reverse quantum annealing to evolve each qubit of the plurality of qubits to a respective second state; the causing a measurement of the respective second state of each qubit of the plurality of qubits and transmission of measured second states of the plurality of qubits to the digital computer; the applying a linear transformation to the measured second states of the plurality of qubits to obtain a predicted output value, the linear transformation including a set of linear parameter weights; and for a subsequent input value in the vector of input values, setting first states of the plurality of qubits to the measured second states of the plurality of qubits.

A non-transitory computer-readable medium can be provided. The non-transitory computer medium can have stored thereon instructions that, when executed by a digital processor, cause the processor to execute any one of the methods described herein.

A system can be provided. The system can include at least one digital computer including at least one digital processor; and at least one analog computer including at least one quantum processor. The at least one quantum processor can include a plurality of qubits and can be operable to perform quantum annealing according to an annealing protocol, in which the annealing protocol comprises reverse quantum annealing. The at least one digital computer can store instructions that, when executed by the digital processor, cause the at least one digital computer in communication with the at least one analog computer to determine a predicted output value corresponding to an input value of a time-series dataset via a reservoir computer. The at least one quantum processor can be operable as a reservoir of the reservoir computer through performance of the quantum annealing according to the annealing protocol.

In some implementations, the at least one quantum processor that can be operable as a reservoir of the reservoir computer can be operable to perform quantum annealing according to: an annealing schedule provided to the at least one quantum processor by the at least one digital computer, in which the annealing schedule determines the annealing protocol; and, Hamiltonian parameters determined by at least a current input value of a time-series dataset.

In some implementations, based on the annealing protocol, the at least one quantum processor can: perform reverse quantum annealing until a point close or at least proximate a quantum critical point (i.e., in a quantum critical region) is reached, such that quantum fluctuations induce a change in quantum state of each qubit of the plurality of qubits from a first state, and subsequently perform forward quantum annealing until each qubit in the plurality of qubits has a respective second state, and each respective second state is a classical state.

In some implementations, the at least one analog computer further includes at least one qubit controller, the at least one qubit controller can generate qubit state control signals based on a signal received from the at least one digital computer, and the at least one qubit controller can transmit each qubit state control signal to a respective qubit of the plurality of qubits to set the first states of the plurality of qubits.

In some implementations, for an initial input data point in the time-series dataset, the at least one qubit controller can set the first states of the plurality of qubits to a same classical state or a same state of superposition, and, for other input data points in the time-series dataset, the at least one qubit controller can set the first states of the plurality of qubits to the second states of the plurality of qubits corresponding to a previous data point in the time-series dataset.

In some implementations, the at least one analog computer can further include: a plurality of couplers in the at least one quantum processor, each coupler of the plurality of couplers communicatively coupling at least two qubits of the plurality of qubits; at least one qubit controller; and, at least one coupler controller. The at least one qubit controller and the at least one coupler controller can generate qubit bias control signals and coupler bias control signals based on a control signal provided by the at least one digital computer to program the at least one quantum computer according to the determined Hamiltonian parameters. The at least one qubit controller and the at least one coupler controller can apply the qubit and coupler bias control signals to respective qubits of the plurality of qubits and respective couplers of the plurality of couplers via respective control interfaces.

In some implementations, the at least one analog computer can include a readout controller operable to measure the second states of the plurality of qubits, and to transmit the second states of the plurality of qubits to the at least one digital computer.

In some implementations, for at least one input value in the time-series dataset: the at least one quantum processor can be operable to be programmed with parameters based on the input value and to perform quantum annealing according to the annealing schedule to evolve a state of each qubit of the plurality of qubits to a respective final state; the at least one digital computer can obtain the final states of the plurality of qubits as an output of the reservoir; and a readout layer of the reservoir computer can be operable to determine the predicted output value corresponding to the respective input value based on the output of the reservoir.

In some implementations, the readout layer of the reservoir computer can be operable to apply a linear transformation to the output of the reservoir to determine the predicted output value corresponding to a respective input value. The linear transformation can include a set of linear parameters weights.

In some implementations, the time-series dataset can further include a target output value corresponding to each input value. The at least one digital computer can store instructions that, when executed by the digital processor, causes the at least one digital computer in communication with the at least one analog computer to: determine a respective predicted output value corresponding to each input value in the time-series dataset based on the output of the reservoir; and optimize the linear parameter weights based on all of the determined predicted output values and corresponding target output values of the time-series dataset to train the readout layer of the reservoir computer.

### BRIEF DESCRIPTION OF THE SEVERAL VIEWS OF THE DRAWING(S)

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings.

FIG. 1 is a schematic diagram of an example topology of a superconducting quantum processor, according to the present disclosure, in accordance with the presently described systems, devices, articles, and methods.

FIG. 2 is a schematic diagram of a circuit of an example superconducting quantum processor, in accordance with the presently described systems, devices, articles, and methods.

FIG. 3 is a schematic diagram of an example system to implement quantum reservoir computing, in accordance with the presently described systems, devices, articles, and methods.

FIG. 4 is a schematic diagram of data flow during an example of quantum annealing-assisted reservoir computing, in accordance with the presently described systems, devices, articles, and methods.

FIGS. 5A, 5B, and 5C are graphs showing an example quantum annealing protocol, at respective times, of a quantum processor used as a physical reservoir, in accordance with the presently described systems, devices, articles, and methods.

FIG. 6 is a flowchart of an example method to train a quantum annealing-assisted reservoir computing model, in accordance with the presently described systems, devices, articles, and methods.

FIG. 7 is a flowchart of an example method to predict an output for an input value using quantum annealing-assisted reservoir computing, in accordance with the presently described systems, devices, articles, and methods.

### DETAILED DESCRIPTION

### Preamble

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures associated with computer systems, server computers, and/or communications networks have not been shown or described in detail to avoid unnecessarily obscuring descriptions of the implementations.

Unless the context requires otherwise, throughout the specification and claims that follow, the word “comprising” is synonymous with “including,” and is inclusive or open-ended (i.e., does not exclude additional, unrecited elements or method acts).

Reference throughout this specification to “one implementation” or “an implementation” means that a particular feature, structure or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

The headings and Abstract of the Disclosure provided herein are for convenience only and do not interpret the scope or meaning of the implementations.

### Example Hybrid Computing System

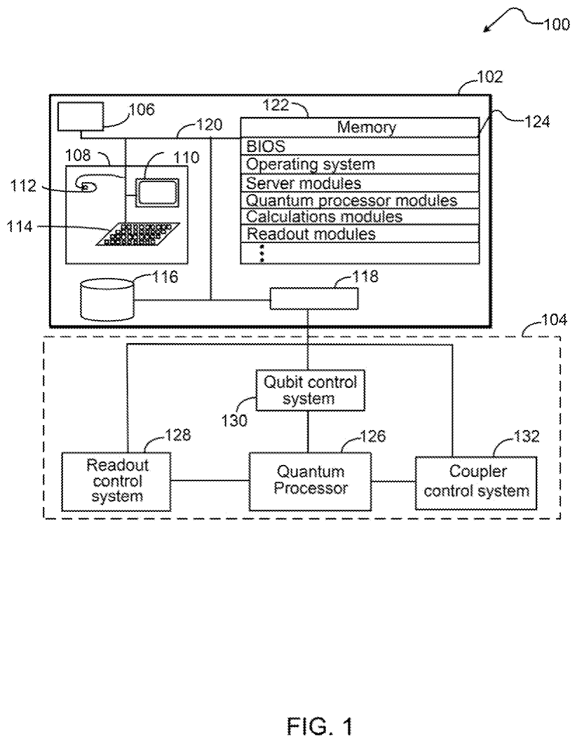

FIG. 1 illustrates a computing system 100 comprising a digital computer 102, in accordance with the presently described systems, devices, articles, and methods. The digital computer 102 includes one or more digital processors 106 that may be used to perform classical digital processing tasks. Digital computer 102 may further include at least one system memory 122, and at least one system bus 120 that couples various system components, including coupling at least one system memory 122 to digital processor(s) 106. At least one system memory 122 may store one or more sets of processor-executable instructions, which may be referred to as modules 124.

The digital processor(s) 106 may be any logic processing unit or circuitry (for example, integrated circuits), such as one or more central processing units (“CPUs”), graphics processing units (“GPUs”), digital signal processors (“DSPs”), application-specific integrated circuits (“ASICs”), programmable gate arrays (“FPGAs”), programmable logic controllers (“PLCs”), etc., and/or combinations of the same.

In some implementations, computing system 100 comprises an analog computer 104, which may include one or more quantum processors 126. Quantum processor 126 may include at least one superconducting integrated circuit. Digital computer 102 may communicate with analog computer 104 via, for instance, a controller 118. Certain computations may be performed by analog computer 104 at the instruction of digital computer 102, such as those described in greater detail herein.

Digital computer 102 may include a user input/output subsystem 108. In some implementations, the user input/output subsystem includes one or more user input/output components such as a display 110, a mouse 112, and/or a keyboard 114.

At least one system bus 120 may employ any known bus structures or architectures, including a memory bus with a memory controller, a peripheral bus, and a local bus. At least one system memory 122 may include non-volatile memory, such as read-only memory (“ROM”), static random-access memory (“SRAM”), Flash NAND; and volatile memory such as random-access memory (“RAM”) (not shown).

Digital computer 102 may also include other non-transitory computer-or processor-readable storage media or a non-volatile memory 116. Non-volatile memory 116 may take a variety of forms, including: a hard disk drive for reading from and writing to a hard disk (for example, a magnetic disk), an optical disk drive for reading from and writing to removable optical disks, and/or a solid state drive (SSD) for reading from and writing to solid state media (for example, NAND-based Flash memory). Non-volatile memory 116 may communicate with digital processor(s) 106 via at least one system bus 120 and may include appropriate interfaces or controllers 118 coupled to at least one system bus 120. Non-volatile memory 116 may serve as long-term storage for processor- or computer-readable instructions, data structures, or other data (sometimes called program modules or modules 124) for digital computer 102.

Although digital computer 102 has been described as employing hard disks, optical disks, and/or solid-state storage media, those skilled in the relevant art will appreciate that other types of non-transitory and non-volatile computer-readable media may be employed. Those skilled in the relevant art will appreciate that some computer architectures employ non-transitory volatile memory and non-transitory non-volatile memory. For example, data in volatile memory may be cached to non-volatile memory or a solid-state disk that employs integrated circuits to provide non-volatile memory.

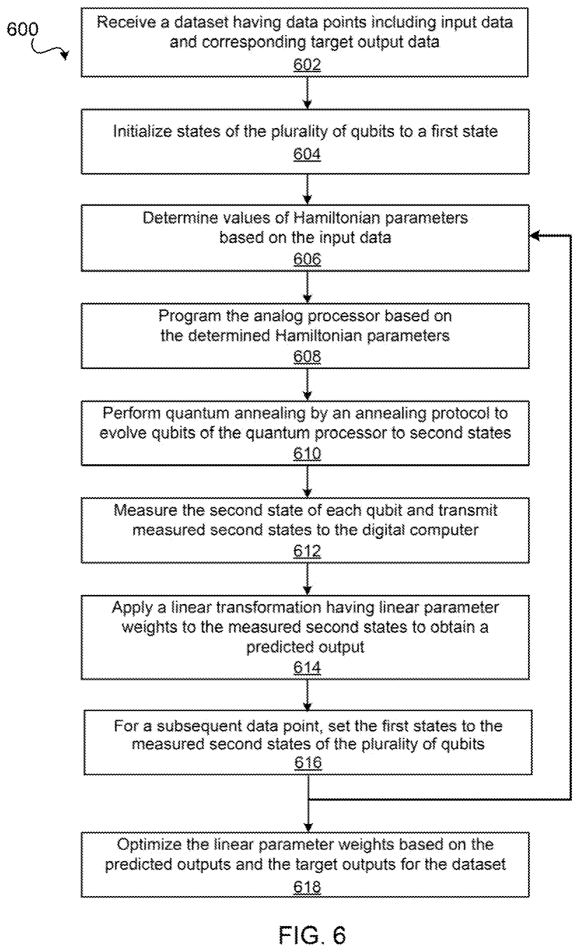

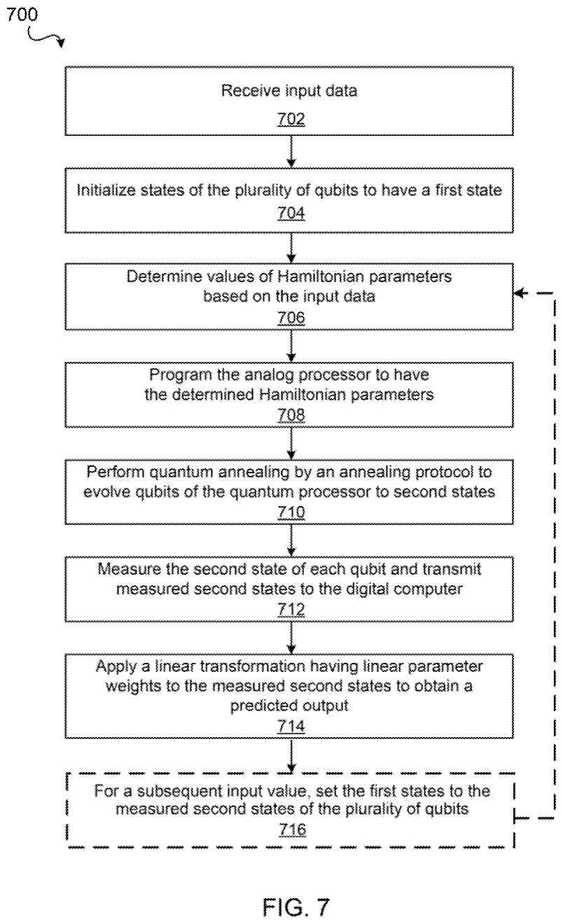

Various processor- or computer-readable and/or executable instructions, data structures, or other data may be stored in at least one system memory 122. For example, at least one system memory 122 may store instructions for communicating with remote clients and scheduling use of resources including resources on the digital computer 102 and analog computer 104. Also, for example, at least one system memory 122 may store at least one of processor executable instructions or data that, when executed by at least one processor, causes the at least one processor to execute the various algorithms to execute instructions. In some implementations, at least one system memory 122 may store processor- or computer-readable calculation instructions and/or data to perform pre-processing, co-processing, and post-processing to analog computer 104. At least one system memory 122 may store a set of analog computer interface instructions to interact with analog computer 104. For example, at least one system memory 122 may store processor- or computer-readable instructions, data structures, or other data which, when executed by a processor or computer causes the processor(s) or computer(s) to execute one, more or all of the acts of the methods described herein, for example the acts of method 600 (FIG. 6) and method 700 (FIG. 7).

Analog computer 104 may include at least one analog processor such as quantum processor 126. Analog computer 104 may be provided in an isolated environment, for example, in an isolated environment that shields the internal elements of the quantum computer from heat, magnetic field, and other external noise. The isolated environment may include a refrigerator, for instance a dilution refrigerator, operable to cryogenically cool the analog processor, for example to temperature below approximately 1 K.

Analog computer 104 may include programmable elements such as qubits, couplers, and other devices (also referred to herein as controllable devices). Qubits may be read out via a readout control system 128. Readout results may be sent to other computer- or processor-readable instructions of digital computer 102. Qubits may be controlled via a qubit control system 130. Qubit control system 130 may include on-chip Digital to Analog Converters (DACs) and analog lines that are operable to apply a bias to a target device. Couplers that couple qubits may be controlled via a coupler control system 132. Coupler control system 132 may include tuning elements such as on-chip DACs and analog lines.

In some implementations, qubit control system 130 and coupler control system 132 may be used to implement a quantum annealing protocol as described herein on analog computer 104. In accordance with some implementations of the present disclosure, a quantum processor, such as quantum processor 126, may be designed to perform quantum annealing and/or adiabatic quantum computation. Examples of quantum processors are described in U.S. Pat. No. 7,533,068.

Alternatively, a quantum processor, such as quantum processor 126, may be a universal quantum computer, and may be designed to perform universal adiabatic quantum computing, or other forms of quantum computation such as gate model-based quantum computation.

### Example Superconducting Quantum Processor

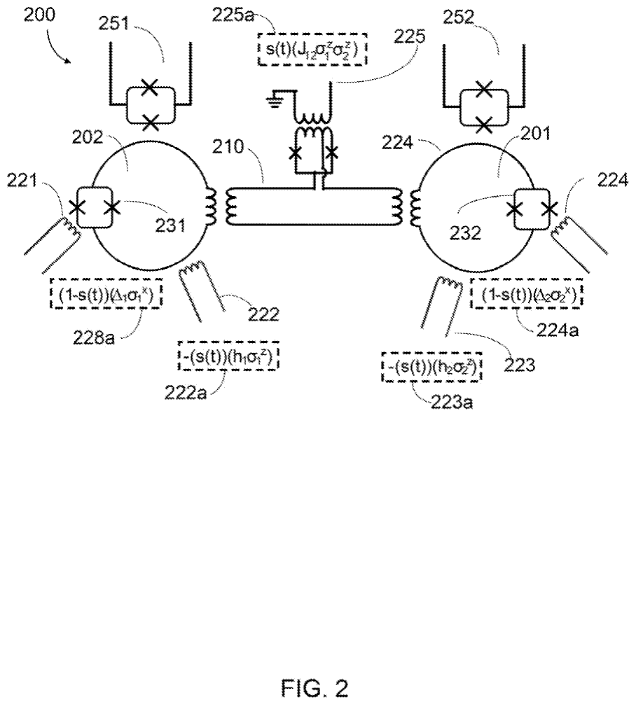

FIG. 2 is illustrates a circuit 200 of an example portion of a superconducting quantum processor, in accordance with the presently described systems, devices, articles, and methods. The superconducting quantum processor to which circuit 200 belongs may be, for example, a portion of analog computer 104 that is included as part of computing system 100. This superconducting quantum processor may be used, for instance, for quantum annealing and/or adiabatic quantum computing.

Circuit 200 includes two qubits 201 and 202, which in some implementations, can be superconducting qubits. Also shown is a tunable coupling (diagonal coupling) provided by a coupler 210 between qubits 201 and 202 (i.e., providing 2-local interaction). While circuit 200 shown in FIG. 2 includes only two qubits 201, 202 and one coupler 210, those of skill in the art will appreciate that a superconducting quantum processor may include any number of qubits and any number of couplers coupling information between them.

Circuit 200 includes a plurality of interfaces 221, 222, 223, 224, 225 that are used to configure and control the state of the superconducting quantum processor. Each interface of plurality of interfaces of interfaces 221, 222, 223, 224, 225 can be realized by a respective inductive coupling structure, as illustrated, as part of a programming subsystem and/or an evolution subsystem. Alternatively, or in addition, plurality of interfaces 221, 222, 223, 224, 225 may be realized by a galvanic coupling structure. In some implementations, one or more interfaces of plurality of interfaces 221, 222, 223, 224, 225 may be driven by one or more flux storage devices or DACs. Such a programming subsystem and/or evolution subsystem may be separate from the superconducting quantum processor, or may be included locally (i.e., on-chip with the superconducting quantum processor). For example, referring to computing system 100 of FIG. 1, locally included programming subsystem and/or optional evolution subsystem can be arranged as part of analog computer 104.

In the operation of the superconducting quantum processor, interfaces 221 and 224 may each be used to couple a flux signal into a respective compound Josephson junction (CJJ) 231 and 232, respectively, of qubits 201 and 202, thereby realizing a tunable tunneling term (the Δᵢ term) in the system Hamiltonian. This coupling provides the off-diagonal σ^{x} terms of the Hamiltonian and these flux signals are examples of “delocalization signals”. Examples of Ham iltonians (and their terms) used in quantum computing are described in greater detail in, for example, U.S. Pat. No. 9,424,526.

Similarly, interfaces 222 and 223 may each be used to apply a flux signal into a respective qubit loop of qubits 201 and 202, thereby realizing the hᵢ terms (dimensionless local fields for the qubits) in the system Hamiltonian. This coupling provides the diagonal σ^{z} terms in the system Hamiltonian. Furthermore, interface 225 may be used to couple a flux signal into coupler 210, thereby realizing the Jᵢⱼ term(s) (dimensionless local fields for the couplers) in the system Hamiltonian. This coupling provides the diagonal σᵢ^{z}σⱼ^{z} terms in the system Hamiltonian.

In FIG. 2, the contribution of each interface of plurality of interfaces 221, 222, 223, 224, 225 to the system Hamiltonian is indicated in broken line boxes 221a, 222a, 223a, 224a, 225a, respectively. As shown, in the example of FIG. 2, broken line boxes 221a, 222a, 223a, 224a, 225a are elements of time-varying Ham iltonians for quantum annealing and/or adiabatic quantum computing.

Throughout this specification and the appended claims, the term “quantum processor” is used to generally describe a collection of physical qubits (e.g., qubits 201 and 202) and qubit couplers (e.g., coupler 210). The physical qubits and the coupler are referred to as the “controllable devices” of a quantum processor and their corresponding parameters (e.g., the qubit hᵢ values and the coupler Jᵢⱼ values) are referred to as the “controllable parameters” of the quantum processor. In the context of a quantum processor, the term “programming subsystem” is used to generally describe the interfaces (e.g., “programming interfaces” 222, 223, and 225) used to apply the controllable parameters to the controllable devices of the superconducting quantum processor and other associated control circuitry and/or instructions. In some implementations, programming interfaces 222, 223, and 225 may be included as part of qubit control system 130 and coupler control system 132 that are part of analog computer 104 in FIG. 1. In some implementations, programming interfaces 222, 223, and 225 may include DACs. DACs may also be considered programmable devices that are used to control controllable devices such as qubits, couplers, and parameter tuning devices.

As previously described, the programming interfaces of the programming subsystem may communicate with other subsystems which may be separate from the quantum processor or may be included locally on the processor, such as arranged as part of analog computer 104 of FIG. 1. The programming subsystem may be configured to receive programming instructions in a machine language of the quantum processor and execute the programming instructions to program the programmable and controllable devices in accordance with the programming instructions. Similarly, in the context of a quantum processor that performs annealing and/or adiabatic quantum computation, the term “evolution subsystem” generally includes the interfaces (e.g., “evolution interfaces” 221 and 224) used to evolve devices such as the qubits of circuit 200 and other associated control circuitry and/or instructions. For example, the evolution subsystem may include analog signal lines and their corresponding interfaces (221, 224) to the qubits (201, 202).

In some implementations, in which the quantum processor is implemented as analog computer 104 of FIG. 1, the controllable devices may be arranged as part of quantum processor 126 and these other subsystems may be at least one of: readout control system 128, qubit control system 130, and coupler control system 132 of analog computer 104. The initial programming instructions may be provided using digital computer 102 and sent to the quantum processor and its corresponding subsystems through digital processor(s) 106.

Circuit 200 also includes readout devices 251 and 252, such that readout device 251 is associated with qubit 201 and readout device 252 is associated with qubit 202. In the example implementation shown in FIG. 2, each of readout devices 251 and 252 includes a direct current superconducting quantum interference device (DC-SQUID) inductively coupled to the corresponding qubit. In the context of circuit 200, the term “readout subsystem” is used to generally describe the readout devices 251, 252 used to read out the final states of the qubits (e.g., qubits 201 and 202) in the superconducting quantum processor to produce a bit string. The readout subsystem may also include other elements, such as routing circuitry (e.g., latching elements, a shift register, or a multiplexer circuit) and/or may be arranged in alternative configurations (e.g., an XY-addressable array, an XYZ-addressable array, etc.), any of which may comprise DACs. Qubit readout may also be performed using alternative circuits, such as that described in U.S. Pat. No. 8,854,074. In some implementations, readout devices 251 and 252 and other elements of the readout subsystem in circuit 200 may form a portion of readout control system 128 in analog computer 104 of FIG. 1.

While FIG. 2 illustrates only two physical qubits (i.e., qubits 201 and 202), one coupler 210, and two readout devices 251, 252, a quantum processor (e.g., processor comprising circuit 200) may employ any number of qubits, couplers, and/or readout devices, including a larger number (e.g., hundreds, thousands or more) of qubits, couplers and/or readout devices. The application of the teachings herein to processors with a different (e.g., larger) number of computational components should be readily apparent to those of ordinary skill in the art.

A superconducting quantum processor may include other types of qubits besides superconducting flux qubits. For example, a superconducting quantum processor may include superconducting charge qubits, transmon qubits, and the like.

### Reservoir Computing

Reservoir computing is a machine learning-based framework for mapping input signals into higher dimensional computational spaces based on non-linear dynamics of a fixed system, which can be referred to as a “reservoir”. In order to determine a predicted output for an input signal, an output state of the reservoir undergoes linear transformation. The weights associated with the parameters of the inputs to the reservoir and within the reservoir are fixed, such that only the weights of the parameters of the output layer are trained.

A reservoir computing framework can be used to determine a predicted output based on given input data belonging to a time-series dataset. Example applications of reservoir computing may include forecasting over time of: renewable energy generation, electricity consumption, satellite and telecommunication systems usage, medical events based on bio-signals (for instance, atrial fibrillation detection based on electrocardiogram features and blood glucose concentration for type 1 diabetes) and/or other observed health data (such as outcomes of patients receiving treatment in a particular hospital wing), meteorology, expected road traffic, and/or stock prices.

A reservoir computing framework can be described as having two components: a reservoir and a readout layer. While reservoir computing is based on classical recurrent neural networks (RNNs), reservoir computing includes conceptual and computational separation between the reservoir and readout layer. Therefore, reservoir computing is not performed by a single network, but instead can be implemented as a framework. A reservoir computing framework can refer to a layered structure that provides generic functionality and organization to perform reservoir computing that can be selectively modified by user-developed additions to provide application-specific features. A reservoir computer can be a system that implements reservoir computing, which, in some implementations, can be based on a reservoir computing framework.

Time series data may be mapped to a higher dimensional computational space via a reservoir. A reservoir inherently exhibits temporal dynamic behavior (an output of the reservoir can affect reservoir outputs corresponding to subsequent inputs, i.e., a memory characteristic), and the prediction of an output value is determined at least based on a previous output state of the reservoir. A readout layer is applied to the higher-level mapping of the input signal (i.e., the reservoir output) to determine the predicted output at a corresponding instance in time.

For instance, to predict a quantity of wind energy generated at a particular time by a plurality of wind turbines at a farm, input data at each time instance may include the following data: wind velocity, air density, temperature, rotor area of each wind turbine, tower height of each wind turbine, etc. Data corresponding to a time instance may be input to a reservoir, which outputs a mapping of this data to a high-level state space based on fading memory of mappings at previous instances in time. As described below, dynamics of the reservoir that are used to predict this mapping might not be based on the dynamics of the problem inputs, but may be a different system entirely. The forecasted quantity of wind energy generated at the time of the input is provided by a transformation of the reservoir output.

The reservoir is a complex system, or a model of a complex system, that has its own set of dynamics separate from those of the problem variables. The reservoir includes one or more nodes having a non-linear response to a given input and is able to store information, such as by connecting the one or more nodes in recurrent loops. In some implementations, a reservoir can be a “virtual reservoir” that is implemented in software by a neural network having randomized connections between nodes, executing on at least one processor. The neural network can be implemented as a random sparse recurrent neural network. In alternative implementations, the reservoir can be a “physical reservoir” based on a real-world system that has inherent non-linearity.

The readout layer of the reservoir computing framework performs a linear transformation on outputs of the reservoir.

The operation of the reservoir and readout layer of the reservoir computing framework can be expressed as a function of time t and input data U. The operation of the reservoir can be described as:

xₜ=f(xₜ₋₁, uₜ)

and the operation of the readout layer can be described as:

\tilde{y}ₜ=Wₒᵤₜh(xₜ)

where uₜ is the input data at a particular time. The output of the reservoir xₜ is a latent higher dimensional space of the reservoir, and the function f describes the dynamics of the reservoir. Here, a higher dimensional space refers to a state space (the set of all configurations for a given problem in its environment, which here is the quantum processor that serves as the reservoir) in which the number of features (i.e., dimensions of a state) of the output data is larger than the number of features of the input data. Information from the current input uₜ and previous inputs, via a previous output of the reservoir xₜ₋₁, is transferred into the new, current reservoir output xₜ by nonlinear and/or chaotic dynamics of the reservoir. The reservoir includes a fading memory, so data determined for previous sequential inputs becomes less prominent over time in the determination of the reservoir output. As such, the output of the reservoir xₜ becomes independent of reservoir output xₜ₋ₜ, when t′→∞.

The output of the readout layer \tilde{y}ₜ is a predicted output value of a time-dependent equation at the current time. The output of the readout layer \tilde{y}ₜ can be determined by using a function h to transform the output of the reservoir xₜ, and applying a linear layer having parameter weights Wₒᵤₜ. Training the models of the reservoir computing framework includes optimizing parameter weights Wₒᵤₜ by using a cost function to attempt to minimize a distance between the predicted output values \tilde{Y} and target output values Y that are provided as part of a training dataset.

The high dimensionality of the reservoir enables classification of the data by providing a linear output. This is due to the general improvement of linear separability in higher dimensional Euclidean spaces. Linear separability is a well-known concept in Euclidean geometry, which describes the ability to separate datasets into one or more groups via at least one line or hyperplane in Euclidean space. In some implementations, a line or hyperplane may be a decision boundary that separates groups containing like data from one another. In machine learning, data may be classified based on its location in Euclidean space with respect to the line or hyperplane.

The reservoir computing framework is agnostic toward particular details of the reservoir dynamics, as long the dynamics are sufficiently complex such that they are expressed by correlation of several variables in a high dimensional space. Often, data is more separable in higher order spaces. So, complex reservoir dynamics may result in linearly separable reservoir outputs, such that the data can be classified by performance of linear regression.

It is also important for reservoir dynamics in a reservoir computer to be reproducible. A consistent relationship between data input to the reservoir and data output from the reservoir is required to provide a same mapping when projecting problem input data into a higher dimensional space. This characteristic allows the higher order representation of data at an instance in time to maintain its relevance to data at other instances across a time-series dataset, making the memory characteristic of the reservoir meaningful.

Although reservoir computing framework is derived from recurrent neural networks, which model sequential data based at least in part on prior data within the sequence, the “black box” nature of the reservoir and need to train only the output layer make overall training significantly less complex. As such, training of the readout layer of the reservoir computer is less resource intensive, in terms of time and processing power, than other machine learning models with similar memory characteristics.

### Quantum Reservoir Computing

As discussed above, a reservoir used in a reservoir computing framework employs nonlinear and/or chaotic dynamics to provide a higher order mapping of a problem's inputs, thereby enabling output classification/prediction using a simple linear transformation layer. Due to the inherent non-linear dynamics of qubits within a quantum processor during computation, a quantum processor is a suitable candidate for a physical reservoir of a reservoir computer. As qubits within a quantum processor is a naturally available system that follows its own dynamics without requiring training of these dynamics, use of a quantum processor as a reservoir may have a lower computational cost in performance of reservoir computing when compared to use of a classical, software-based reservoir (i.e., a “virtual” reservoir).

A quantum reservoir may be advantageous compared to other types of physical reservoirs due to the complexity of dynamics in a quantum system relative to a classical system. The increase in reservoir dynamic complexity through use of a quantum reservoir may lead to a mapping of the problem at a higher order computational space, and consequently a more separable reservoir output. The increased separability of the reservoir output may improve the efficacy of the linear transformation at the readout layer, leading to more accurate output data. In addition, the ability to increase reservoir complexity by increasing the number of qubits, and the resultant complexity of quantum interactions, within the quantum system may be advantageous. An increase in a number of qubits available for quantum computation may result in an exponential increase in the degrees of freedom in a quantum system (i.e., the reservoir), which may increase a memory capacity of the reservoir due to the larger state space.

In some implementations of quantum reservoir computing, physical reservoirs can be realized by gate model quantum processors (also known as “circuit model” quantum processors), such that the reservoir is provided by a sequence of fixed gate circuits. Input data can be transferred into the reservoir via a unitary operation, and the output of a reservoir may be measurements obtained of states of qubits within the gate model quantum processor. The output of the reservoir may then be transformed into predicted output values \tilde{Y} using a linear operation with trainable weights Wₒᵤₜ.

Some implementations of reservoir computing that use a quantum processor as a reservoir may be considered: “artificial quantum reservoir computing”. In such implementations, a quantum dynamical system serving as the reservoir can be realized at each time increment by injecting input data into one ancillary qubit of the gate model quantum processor, and driving the system through an input-independent Hamiltonian. After the system has been driven and the reservoir output can be obtained, the ancillary qubit is discarded and reset before the next time increment. The discarding of the ancillary qubit allows for the system provided by the gate model quantum processor to fulfill the “fading memory” characteristic of the reservoir.

Another implementation of reservoir computing that uses a quantum processor as a reservoir may be referred to as “natural quantum reservoir computing”, which is described in detail by Suzuki et al. (Yudai Suzuki, Qi Gao, Ken C. Pradel , Kenji Yasuoka and Naoki Yamamoto, Natural quantum reservoir computing for temporal information processing, Scientific Reports 12, 1353 (2022), https://doi.org/10.1038/s41598-022-05061-w). Natural quantum reservoir computing uses the intrinsic noise of the quantum device in a gate-model quantum processor as a reservoir based on dissipative quantum dynamics. The dissipative noise arising as a result of qubit decoherence is positively considered as part of dynamics of the reservoir.

While the richness and complexity of quantum systems makes a quantum processor-based reservoir attractive, there may be limitations associated with the use of gate model quantum processors. As gate model quantum processors are typically small and have limited circuit depth, it may be challenging to perform complicated quantum evolution in a space having a suitably high dimension for reservoir computing. For natural quantum reservoir computing, the quality of performance may be constrained by knowledge and controllability of underlying mechanisms of quantum noise in the quantum processor. Quantum circuits also may need to be run an undesirably large number of times to achieve the desired outputs, thereby reducing the advantages associated with using a physical reservoir. In gate model quantum reservoir computing, the Hamiltonian model representing the qubit dynamics is fixed and does not include parameters that change over the course of performance of a quantum computation.

In order to realize the advantages of quantum reservoir computing, a reservoir can be implemented as a quantum processor providing a system with complex dynamics, a high dimensional computation space, and a fading memory. Instead of a gate model quantum processor, a quantum annealing processor may be used as a physical reservoir. The dynamics within a quantum annealing processor can be reproducible and highly complex, due to phenomena such as coherent tunneling and entanglement of qubits.

A variable applied to a term in a Hamiltonian can control an amount of disorder in the system. A change in this variable can follow a defined schedule known as an annealing schedule, which can influence quantum dynamics of qubits in the system. In some implementations, an annealing schedule is a function that defines a rate of change of a characteristic of the system that affects its dynamics.

The annealing schedule of the quantum annealing processor can be controlled, and techniques such as reverse quantum annealing can be employed to control at least some of the system dynamics. Using a quantum annealing processor as a physical reservoir may result in projection of the problem to a higher-order space than may be achievable otherwise, while still maintaining a consistent input-output relationship between each problem input and reservoir output.

There can be provided a reservoir computing framework that uses system dynamics of a quantum annealing processor as a reservoir and measured states of qubits after quantum evolution as an output of the reservoir. The states of qubits after quantum evolution can be obtained subsequent to reverse quantum annealing, for which states of qubits are: initialized to a first state, evolved to a non-classical state, and returned to a final classical state for measurement. The output of the reservoir can be fed into a readout layer, which can include parameter weights that are optimizable using a linear model.

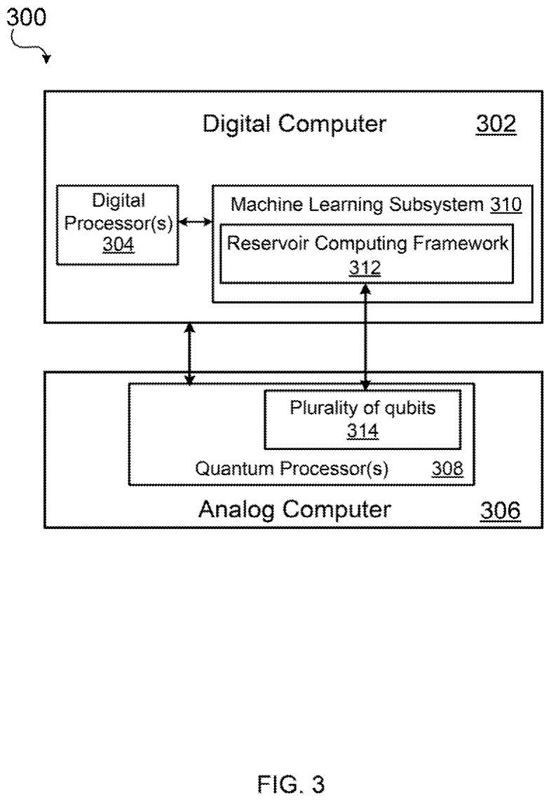

FIG. 3 illustrates an example system that implements quantum reservoir computing, in accordance with the presently described systems, devices, articles, and methods. A reservoir computer 300 shown in FIG. 3 includes a digital computer 302 having at least one digital processor 304, which is communicatively coupled to an analog computer 306 having at least one quantum processor 308.

In some implementations, reservoir computer 300 may be part of a hybrid computing system such as computing system 100 in FIG, 1. In such an implementation, digital computer 302 and digital processor 304 may be digital computer 102 and digital processor(s) 106, respectively. In some implementations, digital computer 302 may be a physical computing system having components arranged in a single location. As well, analog computer 306 and quantum processor 308 may be analog computer 104 and quantum processor 126, respectively.

Digital computer 302 includes digital processor 304 and a machine learning subsystem 310, which are arranged in communication with one another. Machine learning subsystem 310 can be used to perform machine learning. In some implementations, at least a portion of machine learning subsystem 310 may be machine-readable instructions, that, when executed by digital processor 304, perform acts for implementing machine learning methods by reservoir computer 300. These machine-readable instructions may be stored, for example, in a memory associated with digital computer 302, such as at least one system memory 122 of digital computer 102. Additionally, or alternatively, at least a portion of machine learning subsystem 310 may include at least a portion of a digital processor that is dedicated to executing instructions to perform one or more machine learning methods.

Although digital processor 304 is shown as part of digital computer 302 in FIG. 3, digital processor 304 can alternatively be arranged external to, but in communication with, digital computer 302 (for example, as part of a different digital computer). In some implementations, more than one digital processor may be included as part of reservoir computer 300, and at least one digital processor 304 may be arranged within digital computer 302 and one or more of these digital processors may be arranged external to digital computer 302 (for example, as part of one or more different digital computers). In such an implementation, each digital processor arranged external to digital computer 302 may be communicatively coupled to digital computer 302, which may be communicatively coupled to at least one digital processor 304 within digital computer 302 and/or machine learning subsystem 310.

Although machine learning subsystem 310 is shown as part of digital computer 302 in FIG. 3, machine learning subsystem 310 can optionally be arranged in a distributed manner, such that all or a portion of machine learning subsystem 310 is located external to a physical computing system of digital computer 302. For example, a portion of machine learning subsystem 310 may be stored on a cloud and accessed via digital processor 304 of digital computer 302. In another implementation, digital computer 302 may include more than one physical computing systems, and may include components in different physical locations that are in communication with one another.

Machine learning subsystem 310 includes at least a portion of a reservoir computing framework 312. In some implementations, at least a portion of reservoir computing framework 312 may be machine-readable instructions, that, when executed by digital processor 304, perform acts for training and/or deploying reservoir computing and/or quantum reservoir computing. In some implementations, reservoir computing framework 312 may include a portion of the memory associated with digital computer 302, such as at least one system memory 122, so that machine-readable instructions comprising part of the reservoir computing framework may be stored as part of reservoir computing framework 312. Additionally, or alternatively, at least a portion of reservoir computing framework 312 may include at least a portion of a digital processor that is dedicated to executing instructions to perform reservoir computing.

Quantum processor 308 includes a plurality of qubits 314. In some implementations, plurality of qubits 314 can, for example, take the form of qubits 201, 202 of the quantum processor provided at least in part by circuit 200 of FIG. 2.

Analog computer 306 is arranged in communication with digital computer 302. In some implementations, digital processor 304 of digital computer 302 can provide instructions to quantum processor 308 that control the behavior of one or more components of analog computer 306, such as plurality of qubits 314 or couplers in quantum processor 308. In some implementations, digital computer 302 may control one or more components of quantum processor 308 via additional control system circuitry in analog computer 306, such as by qubit control system 130, coupler control system 132, and/or readout control system 128 of computing system 100. In some implementations, digital processor 304 of digital computer 302 can instruct quantum processor 308 to perform computations, such as those described herein to train a readout layer of reservoir computing framework 312 and/or to forecast data using reservoir computing framework 312.

Quantum processor 308 can be an analog processor that performs quantum annealing, and/or adiabatic quantum computing. In some implementations, digital processor 304 of digital computer 302 can transmit signals that instruct quantum processor 308 to perform quantum annealing based on a prescribed annealing schedule. In some implementations, reservoir computing framework 312 can include non-transitory computer-readable instructions, that, when executed by digital processor 304, instruct quantum processor 308 to perform reverse and forward quantum annealing as described herein.

Analog computer 306 can include readout circuitry and/or structures for measuring the states of qubits in plurality of qubits 314. For example, following quantum annealing, a state of each qubit in plurality of qubits 314 may be obtained from quantum processor 308 and transmitted to digital computer 302. In some implementations, measured states of the qubits in plurality of qubits 314 can be provided directly to reservoir computing framework 312 for use in quantum annealing-assisted reservoir computing as described herein. In some implementations, the measured states of the qubits in plurality of qubits 314 can be stored in a memory, including one of: a memory of digital computer 302, such as at least one system memory 122 of digital computer 102; a memory arranged as part of machine learning subsystem 310 and/or reservoir computing framework 312; and a memory located externally to reservoir computer 300, which is communicatively coupled with analog computer 306 and digital computer 302.

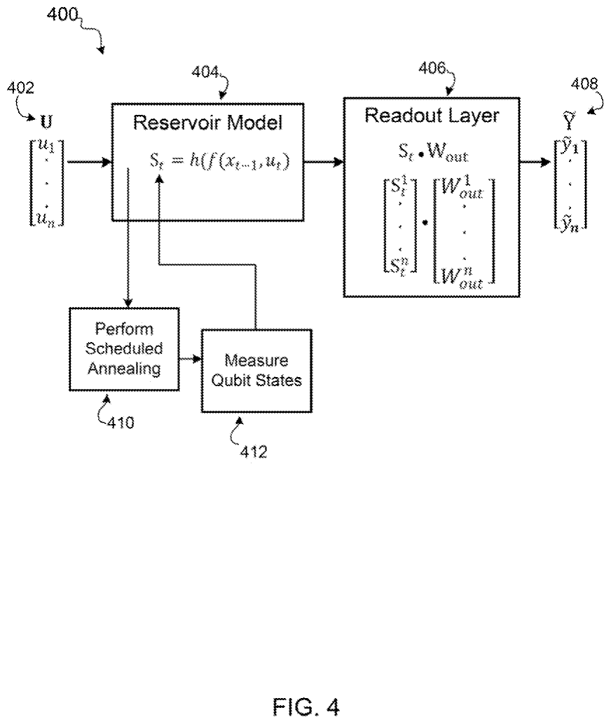

FIG. 4 illustrates a flow of data during quantum annealing-assisted reservoir computing. In some implementations, a data flow 400 can describe quantum annealing-assisted reservoir computing having components performed by both digital computer 102 and analog computer 104 of computing system 100. In some implementations, the quantum annealing-assisted reservoir computing of data flow 400 can be implemented by digital computer 302 in communication with analog computer 306 of reservoir computer 300. More particularly, data flow 400 can be an example of a portion of the data flow within and between reservoir computing framework 312 and quantum processor 308.

Data flow 400 includes a set of input data 402 provided to a reservoir model 404. The output of reservoir model 404 is coupled to a readout layer 406, which provides a set of output data 408.

Input data 402 can be input data expressed as: U={u₁, . . . , uₙ}. Though the dimension of input data 402 is shown as [1, n], input data 402 can be either a vector or a matrix having any dimension. Input data 402 can be time-dependent, and can include one or more time-dependent variables.

Input data 402 is fed into reservoir model 404. Though not shown in FIG. 4, in some implementations, input data 402 can be weighted by a vector of fixed input weights Wᵢₙ prior to, or immediately after, being provided to reservoir model 404. Each variable within input data 402 can have a fixed input weight that can be assigned by a user or can be determined, for example, by an additional machine learning and/or optimization model. In some implementations, such an additional machine learning and/or optimization model can be arranged as part of machine learning subsystem 310 of reservoir computer 300 and/or stored in at least one system memory 122 of computing system 100.

Based on input data 402, reservoir model 404 obtains reservoir output states provided by a physical reservoir, which is embodied as a quantum processor that can perform quantum annealing. Due to the inherent non-linear dynamics of interactions between qubits in the quantum processor, the quantum processor can be leveraged as a computationally inexpensive physical reservoir. The dynamics of the qubits in the quantum processor can separate data in the higher dimensional space to be classifiable through linear regression, which is a required characteristic of a reservoir for use in reservoir computing.

Based on input data 402 at a given time instance uₜ, reservoir model 404 determines an annealing schedule based on an annealing protocol described later herein. This includes preparation of a model based on qubit dynamics as a function of time, such as a Hamiltonian having parameters hᵢ and J_{i,j} that vary as a function of uₜ. The model may be a spin glass Hamiltonian with complex landscape, provided mathematically as:

$${H}_{t} ( s ) = - A ( s ) {\sum }_{i} {σ}_{i}^{x} + B ( s ) [ {\sum }_{i} {h}_{i} ( {u}_{t} ) {σ}_{i}^{z} + {\sum }_{i , j} {J}_{i j} ( {u}_{t} ) {σ}_{i}^{z} {σ}_{j}^{z} ]$$

In some implementations, the input uₜ can be directly translated into variable parameters hᵢ and J_{i,j}. In alternative implementations, input uₜ can undergo transformation for conversion to variable parameters hᵢ and J_{i,j}, for example, by an additional machine learning model such as a neural network. In such implementations, this additional machine learning model can be arranged as part of machine learning subsystem 310 and/or stored in at least one system memory 122.

Reservoir model 404 can be implemented by a digital computer having a digital processor, such as digital computer 302 and digital processor 304, that programs a quantum processor, such as quantum processor 308, to perform quantum annealing based on the spin glass Hamiltonian having parameters tuned based on uₜ and an annealing schedule prescribed by A(s) and B(s).

Blocks 410 and 412 include operations performed by a quantum processor. At block 410, the scheduled annealing is performed. At first, the scheduled annealing protocol includes a period of reverse quantum annealing. This allows for the qubits in the quantum processor, such as plurality of qubits 314 of quantum processor 308, to be initialized to a defined classical state and move toward the states of the qubits being globally superposed over all possible classical states. For additional information regarding reverse quantum annealing, see, for example, U.S. Pat. No. 10,671,937.

Reverse annealing is performed until reaching a point s*, which can be the quantum critical point or a point in near proximity to the quantum critical point. Such a point in near proximity to the quantum critical point is located in a quantum critical region. The quantum critical point is an instance at which continuous phase transitions occur at a temperature of 0 K. At this temperature, thermal fluctuations do not dominate the phase transitions. Instead, quantum phase transitions occur, driven by quantum fluctuations associated with Heisenberg's uncertainty principle. Although it might not be achievable for real systems to reach absolute zero, influence of the quantum critical point can be felt in a broader region surrounding the quantum critical point (herein referred to as: “the quantum critical region”). In the quantum critical region, system dynamics are governed by the same principles as those at the quantum critical point. In the quantum critical region (i.e., at or near or proximate a quantum critical point), states of qubits in a system may be strongly, or near universally, entangled.

At point s*, quantum fluctuations in the system are strong enough to induce a change in state of some or all of the qubits in the quantum processor. Subsequent to reverse annealing, the quantum processor performs forward annealing to complete the evolution of the qubits within the quantum processor. At the end of the forward annealing, the states of the qubits can be represented as classical states, though the state of each qubit is now dependent on its individual qubit dynamics during the annealing process.

At 412, following reverse and forward quantum annealing, the final states of each of the qubits in the quantum processor are measured. In some implementations, the measurement can be performed using readout circuitry and/or structures, which can be controlled, for example, by readout control system 128 of analog computer 104 of FIG. 1. The readout circuitry and/or structures can transmit the measured qubit states to the digital computer.

In some implementations, measuring qubit states at 412 can be performed by quenching the qubits in the quantum processor after the forward annealing portion of the annealing protocol. The quenching includes applying pulse sources to change the potentials of qubits significantly faster than the quantum mechanical evolution of the system. This can include a plurality of pulse sources provided to a plurality of qubits via a synchronized control circuit, which may form a programming source that can be used to apply a fast single flux quantum (SFQ) pulse to the qubits. Further details of fast annealing signals are provided by International Patent Application Publication No. 2023114811.

In other implementations, measuring qubit states at 412 can be performed using projective source measurement. Further details of projective source measurement are provided in US Patent Application Publication No. 2021/0248506.

In some implementations, measuring qubit states at 412 can include readout via projective source measurement at the point at or near or proximate the quantum critical point (i.e., in the quantum critical region) during the quantum annealing protocol prescribed by the annealing schedule. In such implementations, the qubit states in the quantum processor are not localized to classical states; however, the measured qubit states returned to the digital computer are provided as classical states.

The measured qubit states are transmitted to reservoir model 404, and are arranged as a state vector Sₜ including the state of each qubit in the quantum processor expressed as: Sₜ={Sₜ¹, . . . , Sₜ^{N}}, where N is a number of qubits in the quantum processor. The value of each qubit state Sₜⁱ is a classical state, which can be expressed, for example, as: “−1” and “1”, or “0” and “1”, or “spin up” and “spin down”.

The state vector Sₜ is fed into readout layer 406. Readout layer 406 performs a linear transformation on outputs of reservoir model 404 by applying weights Wₒᵤₜ to parameters of a reservoir model output Sₜ. Weights Wₒᵤₜ can be a vector of weights, where each parameter of the reservoir model output Sₜ has a corresponding weight Wₒᵤₜ. Weights Wₒᵤₜ can be expressed as: Wₒᵤₜₜ={Wₒᵤₜ¹, . . . , Wₒᵤₜⁿ}, where n is a number of output states obtained from reservoir model 404.

Readout layer 406 outputs set of output data 408. Set of output data 408 can be expressed as: \tilde{Y}={\tilde{y}₁, . . . , \tilde{y}ₙ}. Though the dimension of output data 408 is shown as [1, n], output data 408 can be either a vector or a matrix having any suitable dimension typically relative to the size of the input to readout layer 406. Output data 408 can be a predicted state of a problem at a particular instance in time.

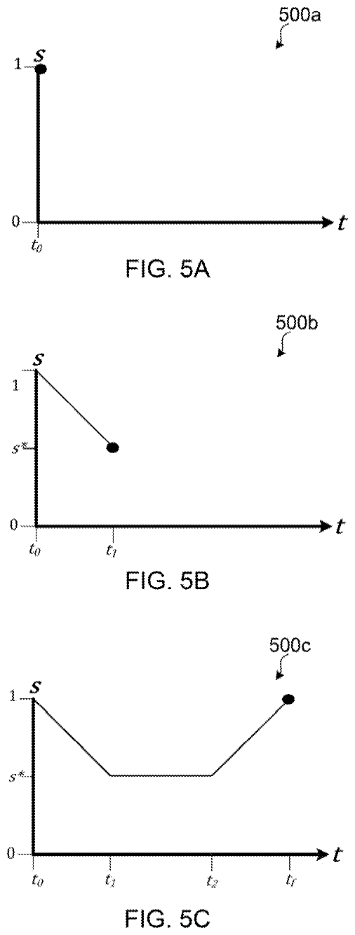

In data flow 400, reservoir model 404 instructs the quantum processor to perform quantum annealing based on a prescribed annealing schedule, which will be described in more detail herein with respect to FIGS. 5A, 5B, and 5C. Use of a scheduled annealing protocol allows for control over system dynamics of qubits within the quantum processor, such as the dynamic complexity and the memory fading properties of the system, and makes reservoir dynamics have a reliably reproducible input-output relationship. By providing an annealing schedule to the quantum processor that includes reverse quantum annealing, the states of qubits can be strategically sampled after annealing to a particular point at which the qubit dynamics have an increased complexity. The increased complexity calls for expression of the dynamics in a higher dimensional space, advantageously making the reservoir output more separable and simpler to classify by a readout layer.

FIGS. 5A, 5B, and 5C illustrate a quantum annealing protocol of a quantum processor used as a physical reservoir, in accordance with the presently described systems, devices, articles, and methods. The annealing protocol may be the prescribed annealing protocol executed at block 410 in data flow 400. A digital processor, such as digital processor(s) 106 or 304, can transmit signals to an analog computer, such as analog computer 104 or 306, to provide the annealing schedule that controls the protocol.

In some implementations, one or more annealing lines may be used to selectively transmit signals to plurality of qubits 314. In some implementations, annealing lines can transmit signals generated by qubit control system 130 and coupler control system 132 of the analog computer to corresponding qubits and couplers. In implementations in which qubits of plurality of qubits 314 include qubits 201, 202, annealing lines can apply signals to each qubit through analog signal lines via evolution interfaces 221 and 224.

FIGS. 5A, 5B, and 5C show plots 500a, 500b, and 500c that illustrate a normalized annealing fraction s as a function of time at respective stages during a prescribed annealing protocol.

In some implementations, the normalized annealing fraction may represent the normalized flux applied to a compound Josephson junction or the normalized persistent current Iₚ of a flux qubit. The normalized annealing fraction s changes monotonically over time during a reverse anneal in a decreasing direction to a minimum value of 0, and changes monotonically over time during a forward anneal in an increasing direction to a maximum value of 1. The normalized annealing fraction may also be referred to as a: “normalized evolution coefficient”. The normalized annealing fraction is a parameter that can vary with time between 0 and 1, and can be used to define an annealing schedule.

In quantum annealing, an evolution Hamiltonian can be expressed as a sum of a negative tunneling Hamiltonian term (also referred to as an initial Hamiltonian term) and a positive problem Hamiltonian term (also referred to as a final Hamiltonian term). The value of the tunneling Hamiltonian term is governed by the variable energy scale coefficient A(s), which represents the transverse, or tunneling, energy of the qubits in the quantum processor. A lowest-energy state of the tunneling Hamiltonian term occurs when all qubits in the quantum processor are in a superposition state of “−1” and “1”. The value of the problem Hamiltonian term is governed by the variable energy scale coefficient B(s) indicating applied energy. A lowest-energy state of the problem Hamiltonian term is a set of classical states providing an answer to a problem being solved (here, qubits states that represent a higher-order mapping of the problem inputs). Values of the variable energy scale coefficient A(s) and the variable energy scale coefficient B(s) change over the course of the anneal based on the normalized annealing fraction s, and the rate and/or direction of quantum evolution during annealing can be controlled based on adjusting the values of the variable energy scale coefficients A(s) and B(s) of the data-dependent Hamiltonian model. Each of the variable energy scale coefficients A(s) and B(s) may have values between 0 and 1.

The behavior of qubits in the quantum processor at stages of the anneal shown in plots 500a, 500b, and 500c may be described below with reference to an example set of qubits. However, it is to be understood that any number of qubits can undergo annealing based on the annealing protocol, and that the quantum processor can include any number of qubits.

First plot 500a shows the annealing protocol at annealing time t=0. Here, a digital computer has instructed the quantum processor to begin the annealing protocol thereby causing the quantum processor to begin performance of quantum annealing, and to have initialized the states of the qubits. At annealing time t=0, first plot 500a indicates that the quantum processor is to perform reverse annealing, as s(0)=1. When s=1, qubits in the quantum processor have a defined classical state (i.e., one of: “−1” and “1”, “0” and “1”, or “spin up” and “spin down”) that can be set or measured by digital or classical devices. In order to set s to “1” and prepare for the reverse annealing process, the Hamiltonian parameters are initialized such that A(s)<<B(s).

At annealing time t=0, all of qubits have a same first classical state. For example, all qubits can be initialized to a state of “1”. For an example case of six qubits, the initial states of the qubits can be expressed as: S_{0,1}={S_{0,1}¹, S_{0,1}², S_{0,1}³, S_{0,1}⁴, S_{0,1}⁴, S_{0,1}⁵, S_{0,1}⁶}={1, 1, 1, 1, 1, 1}. However, this is merely an example and is not intended to be limiting. Instead, all of the qubits can be initialized to an opposite classical state (e.g., “−1”) or a same superimposed qubit state between [−1, 1]. Due to the memory fading characteristic of the system dynamics provided by the quantum evolution, any state can be selected as the initial state S₀ of the qubits without undue influence on the reservoir output at future instances in time.

Second plot 500b shows the annealing protocol at annealing time t=t₁. Second plot 500b indicates that the quantum processor has performed reverse annealing for a duration of t₁, and the annealing fraction s has decreased in value towards s=0. At t₁, the reverse annealing is stopped, and the annealing is paused at a point s* close to or proximate or at the quantum critical point (i.e., in the quantum critical region).

At s*, the quantum interactions between the qubits induce a change in state of some or all of the qubits in the quantum processor. The point s* may occur when the amplitudes of A(s) and B(s) are equal.

In quantum annealing, a network of qubits may be in a state of global superposition over all possible classical states when s=0. At annealing time t₁, the qubits are no longer in their initial state S_{0,1}, but are instead in a state of superposition between the two classical states. For example, between t=t₀ and t=t₁, the above-noted set of six qubits are not in a classical state.

At the point s* in the quantum critical region, the dynamics of the qubits within the quantum processor, and thus the dynamics of the reservoir, are at their most complex. By inputting the problem data into the reservoir having these dynamics, the reservoir projects the problem data to a higher dimensional space at which the reservoir output is linearly separable. This, along with the fading memory property of the qubit dynamics, allows for better determination of temporal relationships between sequential inputs to the reservoir.

In the quantum critical region, the dynamics involve at least multi-qubit coherent tunneling and entanglement, which might not be present or prominent at other points during annealing. The degree of entanglement and multi-qubit coherent tunneling at s* might also not be present or prominent in the sampling of a gate model quantum processor. At s*, it is also highly unlikely that the dynamics of qubits in the quantum processor can be simulated by a classical computer. It is preferable to have reservoir dynamics that are as complex as possible while having a reproducible input-output relationship such that a greater number of correlated variables allow the reservoir dynamics to be expressed in a higher-order Euclidean space to improve separability without the reservoir losing its relevance to the input data. Therefore, the complex, but still reproducible, reservoir dynamics at s* during quantum annealing provides an improvement over classical reservoir computing and gate model quantum-assisted reservoir computing.

Third plot 500c shows the annealing protocol at annealing time t=t_{f}, when the annealing according to the quantum annealing protocol is complete. Third plot 500c indicates that between t₁ and t₂, control signals were provided to the quantum processor to pause the anneal at a point at which s(t₁)=s(t₂)=s*=0. Between t=t₂ and t=t_{f}, the annealing protocol includes performance of forward quantum annealing to complete the evolution of the qubits in the quantum processor. Here, the normalized annealing fraction s increases from s* to 1. At the end of the anneal, A(s)<<B(s), and in some examples A(s)=0.

In some implementations, there might not be a pause in the annealing schedule. Instead, reverse annealing may be performed until the point s* and forward annealing may be performed immediately following the reverse annealing without any pause. In some implementations, the relationship between the normalized annealing fraction and time elapsed might not be linear for both the reverse annealing and the forward annealing.

For the example set of six qubits described above, the state of each qubit has re-localized at s(t_{f})=1 to a single, classical state. The classical state of each qubit may be based on a probability distribution of a particular state being observed after the induced change in state near s*. The classical states of the qubits may be the same or different from one another. For an example set of six qubits, the final states of the qubits could be expressed as: S_{f,1}={S_{f,1}¹, S_{f,1}², S_{f,1}³, S_{f,1}⁴, S_{f,1}⁴, S_{f,1}⁵, S_{f,1}⁶}={−1, −1, −1, −1, 1, 1}. However, this is merely an illustrative example and is not intended to be limiting.

At t_{f}, the qubits have undergone quantum evolution and can be found in classical states, which can be sampled by readout devices that are: part of the quantum processor, on-chip with the quantum processor, and/or in communication with the quantum processor. In some implementations, the qubits evolved can, for example, take the form of qubits 201, 202 of the quantum processor of circuit 200, and readout devices 251 and 252 can be used to obtain the states of qubits 201 and 202, respectively. In some implementations, digital processor 106 can send instructions to analog computer 104 via controller 118 to read out the states of the qubits S_{f,1} by sending a signal to readout control system 128, which can generate control signals that are transmitted to readout devices associated with each qubit in quantum processor 126.

The states of the example set of qubits at a stage corresponding to first plot 500a has been described above at s(t₀)=1 for a first input value in quantum annealing-assisted reservoir computing. In implementations in which the input is a data vector, such as input data 402, the states of the qubits may not be those described above due to the memory properties of the reservoir. Instead, the initial states of the qubits at t₀ of each successive input value are the final measured states of the qubits obtained for the previous input value. For instance, if the final states during the first annealing cycle are S_{f,1}={S_{f,1}¹, S_{f,1}², S_{f,1}³, S_{f,1}⁴, S_{f,1}⁴, S_{f,1}⁵, S_{f,1}⁶}={−1, −1, −1, −1, 1, 1}, then S_{0,2}={S_{0,2}¹, S_{0,2}², S_{0,2}³, S_{0,2}⁴, S_{0,2}⁴, S_{0,2}⁵, S_{0,2}⁶}={S_{f,1}¹, S_{f,1}², S_{f,1}³, S_{f,1}⁴, S_{f,1}⁴, S_{f,1}⁵, S_{f,1}⁶}={−1, −1, −1, −1, 1, 1}.

The fading memory property of the reservoir can be adjusted by adjusting one or both of: the point s* to which the qubits are reverse annealed, and the total annealing time tₐ per annealing cycle. A greater amount of memory fading is achieved by reducing s* and/or increasing tₐ. It may be advantageous to perform reverse quantum annealing as shown in FIGS. 5A, 5B, and 5C with a total annealing time tₐ that enables the quantum evolution of the qubits to be coherent, and such that s* is in the quantum critical region, thereby benefiting from the maximally or near-maximally complex system dynamics at this point. As well, since a small amount of thermal noise would lead to desired memory fading of previous reservoir outputs, use of a physical reservoir governed by dynamics of the quantum annealing protocol of FIGS. 5A, 5B, and 5C might not be negatively affected by noise.

### Methods of Training a Quantum Annealing-Assisted Reservoir Computing Model

FIG. 6 shows a method 600 to train an output layer of a quantum annealing-assisted reservoir computer, in accordance with the present systems, devices, and methods. Method 600 is performed by at least one digital computer in communication with at least one quantum processor. To perform method 600, the digital processor of the digital computer can provide control signals or instructions to the quantum processor in order to cause the quantum processor to complete specified method acts.

In at least some implementations, method 600 can be executed on a hybrid computing system comprising at least one quantum processor and a digital computer with at least one digital processor, such as computing system 100 including digital computer 102, digital processor(s) 106, and quantum processor 126, which can include the quantum processor consisting of circuit 200.

In some implementations, method 600 can be carried out by reservoir computer 300 via digital computer 302 having at least one digital processor 304, which is in communication with analog computer 306 that includes at least one quantum processor 308.

Method 600 comprises acts 602 to 618; however, a person skilled in the art will understand that the number of acts illustrated is an example, and, in some implementations, certain acts may be omitted, further acts may be added, and/or the order of the acts may be changed.

Prior to act 602, method 600 can be initiated, for example, by a call from another program or machine learning model, or directly by a user.

At 602, the digital computer receives a dataset including a plurality of data points. Each data point includes an input and a corresponding target output. The dataset may be a set of training data {U, Y} including n data points, in which U={u₁, . . . , uₙ} is data input to the reservoir and: Y={y₁, . . . , yₙ} are target output values corresponding to each input data point.

In some implementations, digital computer 302 has machine learning subsystem 310, which includes reservoir computing framework 312. The dataset {U,Y} of training data can be data stored within digital computer 302, for example, in memory arranged as part of machine learning subsystem 310 or memory arranged elsewhere as part of digital computer 302. As another example, dataset {U,Y} of training data can be generated during training or execution of a different model within machine learning subsystem 310, and can be passed to reservoir computing framework 312. As yet another example, dataset {U,Y} of training data can originate from a digital computer or memory outside of digital computer 302.

At 604, the digital computer instructs the quantum processor to initialize states of the plurality of qubits to a first state. All qubits of the plurality of qubits can be initialized to a same first state. In some implementations, the first state is one of the classical states “−1” and “1” (or alternatively, “0” and “1” or “spin up” and “spin down”), such that, at the time of initialization, S₀={S₀¹, . . . , S₀^{N}}=+1 or S₀={S₀¹, . . . , S₀^{N}}=−1. In some implementations, the choice of classical state can be randomly selected. In an alternative implementation, the first state can be a state representing a qubit in superposition between [−1,1] that is shared by each qubit in the quantum processor. Due to the memory fading characteristic of the provided system, the choice of initial state does not impact the training of the output layer of the reservoir computer.

The digital computer can provide control signals to circuitry and/or devices within an analog computer that controls the state of the qubits. In some implementations, digital processor(s) 106 of digital computer 102 transmits instructions via controller 118 to qubit control system 130 of analog computer 104. Qubit control system 130 can generate one or more signals that set the state of qubits, such as qubits 201 and 202, within quantum processor 126 or the quantum processor provided by circuit 200.

In some implementations, digital processor 304 of digital computer 302 can execute instructions stored as part of reservoir computing framework 312. These instructions can include instructions to transmit one or more signals to quantum processor 308 and/or analog computer 306, which can result in the generation of one or more signals that set a state of each qubit of plurality of qubits 314 to a same classical state (i.e., one of: “−1” and “1”, or “0” and “1”, or “spin up” and “spin down”) or a same random state.

Each of acts 606 through 616 are performed for each data point in the dataset (here, the training dataset). Acts 606 to 612 and 616 implement a reservoir model (e.g., performance of the functions of a reservoir model) and act 614 implements a readout layer of reservoir computer (e.g., performance of the functions of a readout layer). In some implementations, the reservoir model can be reservoir model 404 (FIG. 4) of data flow 400, including blocks 410 and 412, and the readout layer can, for example, take the form of readout layer 406.

At 606, the digital computer determines values of Hamiltonian parameters based on the input. The Hamiltonian parameters may be hᵢ and J_{i,j}, which represent the dimensionless local fields for the qubits in the quantum processor and the dimensionless local fields for the couplers in the quantum processor, respectively. In the spin glass Hamiltonian model described above, hᵢ and J_{i,j} are dependent on uₜ, which is the input value of the current data point of training dataset {U, Y} under evaluation.

In some implementations, the Hamiltonian parameters are determined by one act selected from a group of: direct translation of the input uₜ into the Hamiltonian parameters hᵢ(uₜ) and J_{i,j}(uₜ), application of a transformation to the input uₜ, and feeding of the input uₜ into a machine learning model.

In some implementations, digital processor 304 of digital computer 302 can execute machine-readable instructions to determine the input-dependent Hamiltonian parameters. In some implementations, these instructions can be stored as part of reservoir computing framework 312.

At 608, the digital computer programs the at least one quantum processor based on the determined Hamiltonian parameters. After determination of the Hamiltonian parameters hᵢ and J_{i,j} based on the input uₜ of the current data point, these parameters are provided to the quantum processor to control qubit biases and coupling strengths, which determine an amount of energy applied to the problem Hamiltonian.

In some implementations, signals are transmitted by digital processor(s) 106, 304 of digital computer 102, 302 to analog computer 104, 306 to instruct the programming of tunable devices in quantum processor 126, 308. Based on these signals, qubit control system 130 and coupler control system 132 can generate control signals to transmit to qubits, such as plurality of qubits 314, which cause behavior corresponding to the determined Hamiltonian parameters. In some implementations, qubits of the plurality of qubits 314 can, for example, include qubits 201, 202 and can be programmed through application of a flux signal into respective superconductive loops via interfaces 222 and 223, respectively. Couplers between qubits of plurality of qubits 314 can, for example, take the form of coupler 210, which can be programmed through application of a flux signal into its superconductive loop via interface 225.

At 610, the at least one quantum processor performs quantum annealing according to a scheduled annealing protocol to evolve each qubit of the plurality of qubits to a second state, in which the annealing protocol comprises reverse quantum annealing. In some implementations, digital processor(s) 106, 304 of digital computer 102, 302 can instruct the quantum processor, such as quantum processor 126, 308 to perform quantum annealing according to an annealing protocol, which can include at least reverse quantum annealing. The annealing protocol can include evolution of qubits in the quantum processor, such as plurality of qubits 314, to a second state. The quantum annealing according to the annealing protocol can provide system dynamics of the reservoir in reservoir computing framework 312, and the second state of the qubits can be the reservoir output.

For the first data point in the training dataset {u₁, y₁}, the first states of the qubits S_{0,1} are S₀ initialized at act 604.

As shown in FIGS. 5A, 5B, and 5C, the annealing protocol is performed by beginning the annealing protocol at s(0)=1, and annealing along the path toward s=0 until s=s*, where s* is a point in the quantum critical region that has dynamics that cannot be simulated by a digital computer. The reverse annealing portion of the annealing protocol induces a change in states of the plurality of qubits. Afterwards, the annealing protocol continues by annealing along a path returning to s=1, and completion of the evolution of the qubits. Here, the state of each qubit of the plurality of qubits returns to a classical state based on the induced change during quantum evolution. The classical states of the qubits at the end of quantum evolution are the second states of the plurality of qubits Sₜ.

At 612, the digital computer instructs measurement of the second state of each qubit, and instructs transmission of the measured second states Sₜ of the qubits to the digital computer, thereby causing the measurement to be taken and transmitted. The second state of each qubit corresponds to the classical state of each qubit at the end of quantum evolution.

In some implementations, digital processor(s) 106, 304 of digital computer 102, 302 can transmit one or more signals to obtain values of the second states Sₜ of the qubits in the quantum processor, such as of plurality of qubits 314 in quantum processor 308 or qubits in quantum processor 126. The signals can be provided to readout control system 128, which can generate one or more control signal to readout devices to retrieve state information from the qubits. In some implementations, readout devices can, for example, take the form of readout devices 251, 252.

Readout of the states of the plurality of qubits can be performed using any suitable method, such as fast annealing or projective source measurement.

The readout system transmits the second states of the qubits to the digital computer. In some implementations, states of plurality of qubits 314 are read out, transmitted to digital computer 302, and optionally stored as part of a memory in digital computer 302 or in communication with digital computer 302. In some implementations, the second states of plurality of qubits 314 can be stored in memory arranged as part of machine learning subsystem 310 or reservoir computing framework 312. In some implementations, the second states of plurality of qubits 314 can be transmitted directly into reservoir computing framework 312 and might not be preserved in memory.

At 614, the digital computer applies a linear transformation to the measured second states of the plurality of qubits to obtain a predicted output. Application of the linear transformation includes application of a set of linear parameter weights. The linear parameter weights can be vector Wₒᵤₜ and can include a corresponding weight for each measured second state in vector Sₜ. The predicted output can be expressed as \tilde{Y}, and may correspond to predicted output data 408 of data flow 400.

In some implementations, digital processor(s) 106, 304 of digital computer 102, 302 can execute machine-readable instructions to apply a linear transformation to Sₜ. The machine-readable instructions can, for example, be stored as part of reservoir computing framework 312. In some implementations, a portion of digital processor 304 reserved for performing machine-readable instructions can be part of reservoir computing framework 312.

At 616, the first set of states of the plurality of qubits are set for a subsequent data point in the dataset. Here, the first set of states set at a subsequent data point are the measured second states of the plurality of qubits for the current data point.

As an example, the measured second states of the plurality of qubits may be S_{f,1}={S_{f,1}¹, S_{f,1}², S_{f,1}³, S_{f,1}⁴, S_{f,1}⁴, S_{f,1}⁵, S_{f,1}⁶}={−1, −1, −1, −1, 1, 1} for a data point {u₁, y₁} at time t₁. For data points {u₂, y₂} to {uₙ₋₁, yₙ₋₁} in the dataset, the plurality of qubits are initialized such that the first state is set to S_{f,t}. To set the first states S_{0,2} of the plurality of qubits for a data point {u₂, y₂}, the first states S_{0,2} are set to those of S_{f,1}, such that S_{0,2}={−1, −1, −1, −1, 1, 1}.

In such implementations, following act 616, method 600 returns to act 606. Acts 606 to 616 are performed for data points {u₂, y₂} to {uₙ₋₁, yₙ₋₁} in the dataset, and acts 606 to 614 are performed for {uₙ, yₙ}.

In some implementations, to set the first states of the plurality of qubits for a subsequent data point in the dataset, signals can be transmitted by digital processor(s) 106, 304 of digital computer 102, 302 to analog computer 104, 306 to instruct the programming of tunable devices in quantum processor 126, 308. Based on these signals, qubit control system 130 can generate control signals to transmit to qubits, such as plurality of qubits 314, which can be used to set first states of the qubit. In some implementations, qubits of the plurality of qubits 314 can, for example, include qubits 201, 202 and can be programmed through application of a flux signal into each of their CJJs 231, 232 via interfaces 221 and 224, respectively.

By setting the first states of a subsequent data point in the dataset to the measured second states of the plurality of qubits at the current data point, the reservoir dynamics become dependent on both the data point {uₜ, yₜ} of the training dataset and the memory of the reservoir.

At 618, the digital computer optimizes the set of linear parameter weights. The optimization is based on the predicted output and the target output for all data points in the training dataset. To optimize the set of linear parameter weights, Wₒᵤₜ, the digital processor can perform linear regression on an output dataset {\tilde{Y}, Y}. Output dataset {\tilde{Y}, Y} includes: the predicted output \tilde{Y}={\tilde{y}₁, . . . \tilde{y}ₙ} of each input U={u₁, . . . uₙ} determined using the reservoir computing framework, and the target output Y={y₁, . . . yₙ} corresponding to each input U={u₁, . . . uₙ} of the training dataset. This optimization provides the training of the readout layer of the reservoir computer, and is only performed once based on the entire dataset.

In some implementations, digital processor(s) 106, 304 of digital computer 102, 302 can execute machine-readable instructions to perform the optimization process. In an example, these machine-readable instructions can be stored as part of reservoir computing framework 312. In another example, a portion of a digital processor reserved for performing machine-readable instructions for the optimization can be part of reservoir computing framework 312. The determined optimal parameter weights can be stored as part of reservoir computing framework 312 to be used when deploying the framework with the trained readout layer at a later time.

After 618, method 600 is terminated until, for example, it is invoked or called again.

In some implementations, the first states of the plurality of qubits are the initialized state as described at act 604 only for the first data point in the dataset. For subsequent data points in the dataset, the first states correspond to the second states of the plurality of qubits that were sampled from the quantum processor for the previous data point. Use of the previous second states as the current first states provides the memory characteristic when using qubit dynamics during quantum annealing as a physical reservoir.

Training a readout layer of a reservoir computer according to method 600 may be less resource intensive and/or result in more accurate predicted outputs than training a readout layer of a reservoir computer with a classical virtual reservoir, a classical physical reservoir, or a gate model-based quantum processor as a physical reservoir. Training according to method 600 leverages the complexity of the system dynamics of the quantum processor in the quantum critical region to obtain data that is more separable in a high dimensional space than outputs of other types of reservoirs. The higher separability in higher dimensional space improves the linear separability of the predicted output data of the reservoir computing model. As a result, this improves the classification of the output data obtained via linear regression. Therefore, more optimal values of linear weights Wₒᵤₜ can be determined during training of the output layer of the reservoir computer.

The above-described advantageous dynamics are realized by using dynamics of qubits in a quantum processor during a quantum annealing protocol as the dynamics that govern of the reservoir. In method 600, the quantum processor can be annealed in the reverse direction until point s* due to the controllability of the annealing schedule and parameters of the qubits and couplers. Use of an annealing protocol determined by a prescribed annealing schedule ensures reproducibility of system dynamics. By using a data-dependent Hamiltonian model, suitable Hamiltonian parameters for each input value of the training set can be used to influence qubit behavior during annealing and thereby the reservoir output.

The inherent dynamics of qubits in the quantum processor during annealing beneficially result in training by method 600 being time-efficient, as the reservoir inherently provide consistent dynamics without training, and only one anneal may be involved per data point in the dataset. In contrast, to train a quantum reservoir of a gate model quantum processor, multiple instances of running a circuit may be required per data point in a training dataset.

### Methods of Determining Predicted Data Using Quantum Annealing-Assisted Reservoir Computing

After a readout layer of a quantum annealing-assisted reservoir computer has been trained, the reservoir computing framework can be deployed to predict output data for a time domain problem, given a set of input data. In some implementations, method 600 can be used to train a readout layer of a reservoir computing framework, such as reservoir computing framework 312, to determine optimal linear parameter weights Wₒᵤₜ. The reservoir computing framework including the trained readout layer can be stored in memory associated with reservoir computing framework 312, and can be deployed through execution of machine-readable instructions to perform reservoir computing on either digital computer 302 using digital processor 304 or on another digital processor external to, but in communication with, digital computer 302. Use of a deployed and trained reservoir computing framework to perform reservoir computing can be similar to data flow 400 of FIG. 4.

FIG. 7 shows a method 700 to predict output data for given input value using a quantum annealing-assisted reservoir computer, in accordance with the present systems, devices, and methods. Method 700 is performed by at least one digital computer in communication with at least one quantum processor. To perform method 700, the digital processor of the digital computer can provide control signals or instructions to the quantum processor to cause the quantum processor to complete specified method acts.

In at least some implementations, method 700 can be executed on a hybrid computing system comprising at least one quantum processor and a digital computer with at least one digital processor, such as computing system 100 including digital computer 102, digital processor(s) 106, and quantum processor 126 or the quantum processor consisting of circuit 200.

In some implementations, method 600 can be carried out by reservoir computer 300 via digital computer 302 having at least one digital processor 304 or a different digital computer, which is in communication with analog computer 306 that includes at least one quantum processor 308.

Method 700 comprises acts 702 to 714; however, a person skilled in the art will understand that the number of acts illustrated is an example, and, in some implementations, certain acts may be omitted, further acts may be added, and/or the order of the acts may be changed.

Prior to act 702, method 700 can be initiated, for example, by a call from another program or machine learning model, or directly by a user.

At act 702, the digital computer receives an input value. In some implementations, the input can be a single value. In other implementations, the input data can be an input dataset including a vector of input values. An input dataset can be input data U including n data points, where U={u₁, . . . , uₙ}. The input data U can be a time-series dataset, in which the data points represent a sequence of input values at specified instances in time. The input dataset can, for example, take the form of input data 402 of data flow 400.

Acts 704 to 716 are similar to acts 604 to 616 performed while training the quantum annealing-assisted reservoir computing model by method 600.

At act 704, the digital computer instructs the quantum processor to initialize states of the plurality of qubits to a first state. For predicting an output value for a single input u or a first input in an input dataset u₁, the plurality of qubits area all initialized to have a same first state S₀, which may be a same classical state or a same superimposed state in the range [−1, 1]. The digital computer can transmit a signal to a device in the quantum processor, such as a device within qubit control system 130, which instructs generation of one or more control signals to set the first state of each qubit in the quantum processor.

Each of acts 706 through 716 are performed for each input value in the input dataset. Acts 706 to 712 and 716 implement a reservoir model (e.g., perform functions of a reservoir model) and act 714 implements a readout layer (e.g., performs functions of a readout layer) of the reservoir computer. In some implementations, the reservoir model can, for example, take the form of reservoir model 404 of data flow 400, including blocks 410 and 412, and the readout layer may be readout layer 406.

At 706, the digital computer determines values of Hamiltonian parameters based on the input value. The values hᵢ and J_{i,j} of a spin glass Hamiltonian model are determined based on the input data uₜ.

At 708, the digital computer programs the at least one quantum processor to have the determined Hamiltonian parameters based on uₜ. The digital computer, such as digital computer 302, can transmit one or more signals to an analog computer, such as analog computer 306, that generates control signals for application of biases corresponding to hᵢ(uₜ) and J_{i,j}(uₜ) to plurality of qubits 314 and couplers in quantum processor 308.

At 710, the at least one quantum processor performs reverse quantum annealing to evolve each qubit of the plurality of qubits to a second state. For prediction of an output value for a single input u or a first input in an input dataset u₁, each qubit of the plurality of qubits begins the anneal in the initialized same first state S₀. For subsequent inputs in an input dataset u₂ to uₙ, the plurality of qubits begins the anneal in the first state Sₜ₋₁. Quantum annealing is performed according to the annealing protocol as described with respect to FIGS. 5A, 5B, and 5C, including performance of reverse quantum annealing to induce a change of state in each of the qubits, and then performance of forward quantum annealing to complete quantum evolution, with or without a pause, which resolves the state of each qubit to a classical, second state.

At 712, the digital computer provides instructions to cause measurement of the second state of each qubit, and to cause transmission of the measured second states of the qubits to the digital computer. At 714, the digital computer obtains a predicted output through application of a linear transformation to the measured second states of the qubits. The linear transformation includes a set of linear parameter weights Wₒᵤₜ. The predicted output can be expressed as \tilde{Y}, and corresponds to predicted output data 408 of data flow 400.

After 716, method 700 is terminated until, for example, method 700 is invoked or called again.

Prediction of an output based on a given input value using the quantum annealing-assisted reservoir computing model according to method 700 may produce better results than a prediction determined using classical reservoir computing model and quantum reservoir computing with a gate model-based quantum processor as the reservoir. Use of the annealing protocol as described with respect to FIGS. 5A, 5B, and 5C allows for reproducible and controllable system dynamics within the quantum processor. Due to the ability to control the annealing schedule, measured states of qubits that serve as the reservoir output can have a distribution based on the advantageously complex dynamics within the quantum processor at point s*. These dynamics may provide better separability in the higher dimensional space, which may lead to predicted output values \tilde{Y}determined using the reservoir computer having better accuracy compared to those of reservoir computers that employ reservoirs with less complex dynamics. The improvements to the predicted output accuracy may also be greater if the reservoir computer used to perform method 700 is trained according to method 600 to optimize linear parameter weights Wₒᵤₜ.

Other relative improvements to accuracy of predicted output values \tilde{Y} may arise from programming parameters of the quantum processor based on a data-dependent Hamiltonian model instead of the fixed Hamiltonian model of quantum reservoir computing using a gate model quantum processor. As previously described with respect to training according to method 600, prediction of an output according to method 700 may also be quicker than by reservoir computing using either a classical reservoir or using a gate model quantum processor as a reservoir.

### Post-Amble

The above described method(s), process(es), or technique(s) could be implemented by a series of processor readable instructions stored on one or more non-transitory processor-readable media. Some examples of the above described method(s), process(es), or technique(s) method are performed in part by a specialized device such as an adiabatic quantum computer or a quantum annealer or a system to program or otherwise control operation of an adiabatic quantum computer or a quantum annealer, for instance a computer that includes at least one digital processor. The above described method(s), process(es), or technique(s) may include various acts, though those of skill in the art will appreciate that in alternative examples certain acts may be omitted and/or additional acts may be added. Those of skill in the art will appreciate that the illustrated order of the acts is shown for example purposes only and may change in alternative examples. Some of the example acts or operations of the above described method(s), process(es), or technique(s) are performed iteratively. Some acts of the above described method(s), process(es), or technique(s) can be performed during each iteration, after a plurality of iterations, or at the end of all the iterations.

The above description of illustrated implementations, including what is described in the Abstract, is not intended to be exhaustive or to limit the implementations to the precise forms disclosed. Although specific implementations of and examples are described herein for illustrative purposes, various equivalent modifications can be made without departing from the spirit and scope of the disclosure, as will be recognized by those skilled in the relevant art. The teachings provided herein of the various implementations can be applied to other methods of quantum computation, not necessarily the example methods for quantum computation generally described above.

The various implementations described above can be combined to provide further implementations. All of the commonly assigned US patent application publications, US patent applications, foreign patents, and foreign patent applications referred to in this specification and/or listed in the Application Data Sheet are incorporated herein by reference, in their entirety, including but not limited to: U.S. Pat. Nos. 7,135,701; 7,418,283; 7,533,068; 8,008,942; 8,195,596; 8,190,548; 8,421,053; 8,854,074; 9,424,526; and, 10,671,937; US Patent Application Publication No. 2021/0248506; International Patent Application Publication No. 2023114811; and U.S. Patent Application 63/413,325.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A method to train an output layer of a reservoir computer performed by at least one digital computer in communication with at least one quantum processor, the at least one quantum processor including a plurality of qubits, the method comprising:
receiving, by the at least one digital computer, a dataset comprised of a plurality of data points, each data point including an input and a corresponding target output;
initializing, by the at least one digital computer, states of the plurality of qubits to a first state;
for each data point in the dataset:
determining, by the at least one digital computer, values of Hamiltonian parameters based on the input,
programming, by the at least one digital computer, the at least one quantum processor based on the determined Hamiltonian parameters,
causing, by at least one digital computer, the at least one quantum processor to perform quantum annealing according to an annealing protocol to evolve each qubit of the plurality of qubits to a respective second state, the annealing protocol comprising performance of reverse quantum annealing,
causing, by the at least one digital computer, measurement of the respective second state of each qubit of the plurality of qubits and transmission of measured second states of the plurality of qubits to the digital computer,
applying, by the at least one digital computer, a linear transformation to the measured second states of the plurality of qubits to obtain a predicted output, the linear transformation including a set of linear parameter weights, and
for a subsequent data point in the dataset, setting, by the at least one digital computer, the first states of the plurality of qubits to the measured second states of the plurality of qubits; and
optimizing, by the at least one digital computer, the set of linear parameter weights, the optimizing based on the predicted output and the target output for all data points in the dataset.

2. The method of claim 1, wherein the causing the at least one quantum processor to perform quantum annealing according to an annealing protocol comprises performing reverse quantum annealing until a point in a quantum critical region, such that quantum fluctuations induce a change in state of each qubit of the plurality of qubits.

3. The method of claim 2, wherein after the performing reverse quantum annealing until a point in a quantum critical region, the causing the at least one quantum processor to perform quantum annealing according to an annealing protocol further comprises causing, by at least one digital computer, the at least one quantum processor to perform forward quantum annealing until each qubit in the plurality of qubits has a respective classical state, wherein the respective classical state of each qubit is the respective second state.

4. The method of claim 1, wherein the determining values of Hamiltonian parameters based on the input comprises determining values of Hamiltonian parameters for a spin glass Hamiltonian model having parameters that are a function of the input.

5. The method of claim 1, wherein the determining values of Hamiltonian parameters based on the input comprises one of: directly translating the input into the Hamiltonian parameters, applying a transformation to the input, and feeding the input into a machine learning model.

6. The method of claim 1, wherein the initializing the states of the plurality of qubits to a first state comprises initializing a state of each qubit of the plurality of qubits to a same classical state or a same state of superposition.

7. The method of claim 1, wherein the optimizing the set of linear parameter weights comprises minimizing a distance between the predicted output and the corresponding target output using a cost function.

8. The method of claim 1, wherein the optimizing the set of linear parameter weights comprises performing linear regression on the predicted output and the target output for all data points in the dataset.

9. A non-transitory computer-readable medium having stored thereon instructions that, when executed by a digital processor, cause the processor to execute the method according to claim 1.

10. A method to determine a predicted outcome for an input value performed by at least one digital computer in communication with at least one quantum processor, the at least one quantum processor including a plurality of qubits, the method comprising:
receiving, by the at least one digital computer, the input value;
initializing, by the at least one digital computer, states of the plurality of qubits to a first state;
determining, by the at least one digital computer, values of Hamiltonian parameters based on the input value;
programming, by the at least one digital computer, the at least one quantum processor based on the determined Hamiltonian parameters;
causing, by the at least one digital computer, the at least one quantum processor to perform quantum annealing according to an annealing protocol to evolve each qubit of the plurality of qubits to a respective second state, the annealing protocol comprising performance of reverse quantum annealing;
causing, by the at least one digital computer, a measurement of the respective second state of each qubit of the plurality of qubits and transmission of measured second states of the plurality of qubits to the digital computer; and
applying, by the at least one digital computer, a linear transformation to the measured second states of the plurality of qubits to obtain a predicted output value, the linear transformation including a set of linear parameter weights.

11. The method of claim 10, wherein the causing the at least one quantum processor to perform quantum annealing according to an annealing protocol comprises causing the at least one quantum processor to perform reverse quantum annealing until a point in a quantum critical region, such that quantum fluctuations induce a change in state of each qubit of the plurality of qubits.

12. The method of claim 11, wherein, after performing the reverse quantum annealing until a point in a quantum critical region, the causing the at least one quantum processor to perform quantum annealing according to an annealing protocol further comprises causing the at least one quantum processor to perform forward quantum annealing until each qubit in the plurality of qubits has a respective classical state, wherein the respective classical state of each qubit is the respective second state.

13. The method of claim 10, wherein the determining values of Hamiltonian parameters based on the input comprises determining values of Hamiltonian parameters for a spin glass Hamiltonian model having parameters that are a function of the input value.

14. The method of claim 10, wherein the determining values of Hamiltonian parameters based on the input value comprises one of: directly translating the input value into the Hamiltonian parameters, applying a transformation to the input value, and feeding the input value into a machine learning model.

15. The method of claim 10, wherein the initializing the states of the plurality of qubits to a first state comprises initializing a state of each qubit of the plurality of qubits to a same classical state or a same random state.

16. The method of claim 10, wherein the input value is a vector of input values, and the following acts are performed sequentially for each input value in the vector of input values:
the determining values of Hamiltonian parameters based on the input value;
the programming the at least one quantum processor based on determined Hamiltonian parameters;
the causing the at least one quantum processor to perform quantum annealing according to an annealing protocol to evolve each qubit of the plurality of qubits to a respective second state, the annealing protocol comprising performance of reverse quantum annealing;
the causing a measurement of the respective second state of each qubit of the plurality of qubits and transmission of measured second states of the plurality of qubits to the digital computer;
the applying a linear transformation to the measured second states of the plurality of qubits to obtain a predicted output value, the linear transformation including a set of linear parameter weights; and
for a subsequent input value in the vector of input values, setting first states of the plurality of qubits to the measured second states of the plurality of qubits.

17. A non-transitory computer-readable medium having stored thereon instructions that, when executed by a digital processor, cause the processor to execute the method according to claim 10.

18. A system comprising:
at least one digital computer comprising at least one digital processor; and
at least one analog computer comprising at least one quantum processor, the at least one quantum processor including a plurality of qubits and operable to perform quantum annealing according to an annealing protocol, wherein the annealing protocol comprises reverse quantum annealing,
wherein the at least one digital computer stores instructions that, when executed by the digital processor, causes the at least one digital computer in communication with the at least one analog computer to determine a predicted output value corresponding to an input value of a time-series dataset via a reservoir computer, and wherein the at least one quantum processor is operable as a reservoir of the reservoir computer through performance of the quantum annealing according to the annealing protocol.

19. The system of claim 18, wherein the at least one quantum processor that is operable as a reservoir of the reservoir computer is operable to perform quantum annealing according to:
an annealing schedule provided to the at least one quantum processor by the at least one digital computer, wherein the annealing schedule determines the annealing protocol, and
Hamiltonian parameters determined by at least a current input value of the time-series dataset.

20. The system of claim 18, wherein, based on the annealing protocol, the at least one quantum processor is to:
perform reverse quantum annealing until a point in a quantum critical region, such that quantum fluctuations induce a change in quantum state of each qubit of the plurality of qubits from a first state, and
subsequently perform forward quantum annealing until each qubit in the plurality of qubits has a respective second state, wherein each respective second state is a classical state.

21. The system of claim 20, wherein the at least one analog computer further comprises at least one qubit controller, the at least one qubit controller is to generate qubit state control signals based on a signal received from the at least one digital computer, and the at least one qubit controller is to transmit each qubit state control signal to a respective qubit of the plurality of qubits to set the first states of the plurality of qubits.

22. The system of claim 21, wherein, for an initial input data point in the time-series dataset, the at least one qubit controller sets the first states of the plurality of qubits to a same classical state or a same state of superposition, and,
for other input data points in the time-series dataset, the at least one qubit controller sets the first states of the plurality of qubits to the second states of the plurality of qubits corresponding to a previous data point in the time-series dataset.

23. The system of claim 19, wherein the at least one analog computer further comprises:
a plurality of couplers in the at least one quantum processor, each coupler of the plurality of couplers communicatively coupling at least two qubits of the plurality of qubits;
at least one qubit controller; and,
at least one coupler controller,
wherein the at least one qubit controller and the at least one coupler controller generate qubit bias control signals and coupler bias control signals based on a control signal provided by the at least one digital computer to program the at least one quantum computer according to the determined Hamiltonian parameters, and
the at least one qubit controller and the at least one coupler controller apply the qubit and coupler bias control signals to respective qubits of the plurality of qubits and respective couplers of the plurality of couplers via respective control interfaces.

24. The system of claim 20, wherein the at least one analog computer comprises a readout controller operable to measure the second states of the plurality of qubits, and to transmit the second states of the plurality of qubits to the at least one digital computer.

25. The system of claim 18, wherein, for at least one input value in the time-series dataset:
the at least one quantum processor is operable to be programmed with parameters based on the input value and to perform quantum annealing according to an annealing schedule to evolve a state of each qubit of the plurality of qubits to a respective final state;
the at least one digital computer obtains the final states of the plurality of qubits as an output of the reservoir; and
a readout layer of the reservoir computer is operable to determine the predicted output value corresponding to the respective input value based on the output of the reservoir.

26. The system of claim 25, wherein the readout layer of the reservoir computer is operable to apply a linear transformation to the output of the reservoir to determine the predicted output value corresponding to a respective input value, wherein the linear transformation includes a set of linear parameters weights.

27. The system of claim 26, wherein the time-series dataset further includes a target output value corresponding to each input value, and the at least one digital computer stores instructions that, when executed by the digital processor, causes the at least one digital computer in communication with the at least one analog computer to:
determine a respective predicted output value corresponding to each input value in the time-series dataset based on the output of the reservoir; and
optimize the linear parameter weights based on all of the determined predicted output values and corresponding target output values of the time-series dataset to train the readout layer of the reservoir computer.
